(19) United States
(12) Patent Application Publication
(10) Pub. No.: US 2015/0178744 A1
(43) Pub. Date: Jun. 25, 2015

(54) Methods and systems for signals management

(71) Applicant: Commerce Signals, Inc., Davidson, NC (US)

(72) Inventor: Thomas Noyes, Davidson, NC (US)

(73) Assignee: COMMERCE SIGNALS, INC., Davidson, NC (US)

(21) Appl. No.: 14/633,770

(22) Filed: Feb. 27, 2015

Related U.S. Application Data
(63) Continuation-in-part of application No. 14/214,253, filed on Mar. 14, 2014.
Application No. 14/214,253 is a continuation-in-part of application No. 14/214,232, filed on Mar. 14, 2014.
(60) Provisional application No. 61/791,297, filed on Mar. 15, 2013.
(60) Provisional application No. 61/791,297, filed on Mar. 15, 2013.

(51) Int. Cl. G06Q 30/02; G06Q 30/06

(52) U.S. Cl. CPC G06Q 30/0201; G06Q 30/0635

(57) ABSTRACT

Methods and systems for managing signals based upon agreements, parameters, and rules governing signal(s) use, including limitations on signal use. Signals are indicators of data that are derived from data sources and abstracted to protect the underlying data. The signal owner first converts its own underlying data into a “signal” or indicator that represents the data without disclosing it or providing it.

### CROSS REFERENCE TO RELATED APPLICATIONS

This application claims priority from one or more co-pending US patent applications; it is a Continuation-in-Part of application Ser. No. 14/214,253, filed Mar. 14, 2014 and Ser. No. 14/214,232 filed Mar. 14, 2014, which claim the benefit of U.S. Provisional Application No. 61/791,297, filed Mar. 15, 2013, each of which are incorporated herein by reference in its entirety.

### BACKGROUND OF THE INVENTION

1. Field of the Invention

The present invention relates to methods and systems for providing management for distributed signals or indicators by signal sellers for distribution and sale to signal buyers, for use toward advertising or other objectives.

2. Description of the Prior Art

Generally, it is known in the prior art to provide market signals as information passed between participants in a market. Examples of relevant art documents include the following:

U.S. Patent Application Publication No. 2011/0178845 for “System and Method for Matching Merchants to a Population of Consumers” by inventors Rane, et al., filed Jan. 20, 2010, describes a process of data analysis for the purpose of improving targeted advertising and analytics of data, with the major focus on drawing useful inferences for various entities from aggregated data, wherein entities are not limited to businesses and may include government agencies (census, polling data, etc.).

U.S. Patent Application Publication No. 2012/0233206 for “Methods and Systems for Electronic Data Exchange Utilizing Centralized Management Technology” by inventors Peterson, et al., filed May 24, 2012, describes an exchange of data among business entities and the process of disclosing/receiving data and a central management system for companies engaged in strategic partnership or alliance, whereas Patent 1 deals with a market place dynamic rather than a data exchange within a locked-in partnership management.

U.S. Patent Application Publication No. 2012/0066062 for “Systems and Methods to Present Triggers for Real-Time Offers” by inventors Yoder, et al., filed Aug. 8, 2011, describes collecting consumer transaction data for the benefit of targeted advertisements and an auctioning process (auction engine) for providing data clusters to clients. For example, cardholders may register in a program to receive offers, such as promotions, discounts, sweepstakes, reward points, direct mail coupons, email coupons, etc. The cardholders may register with issuers, or with the portal of the transaction handler. Based on the transaction data or transaction records and/or the registration data, the profile generator is to identify the clusters of cardholders and the values representing the affinity of the cardholders to the clusters. Various entities may place bids according to the clusters and/or the values to gain access to the cardholders, such as the user. For example, an issuer may bid on access to offers; an acquirer and/or a merchant may bid on customer segments. An auction engine receives the bids and awards segments and offers based on the received bids. Thus, customers can get great deals; and merchants can get customer traffic and thus sales.

U.S. Patent Application Publication No. 2011/0246309 for “Method, stored program, and system for improving descriptive profiles” by inventor Shkedi, filed May 25, 2011, describes a process that enables entities to acquire databanks of user profiles that can add to existing knowledge of user profile data and the process is described as a transaction in that the entities disclose a set of profile information in exchange for additional, helpful data relevant to the disclosed data.

U.S. Patent Application Publication No. 2012/0323954 for “Systems and methods for cooperative data exchange” by inventors Bonalle, et al., filed Jun. 14, 2011, describes methods that enable business entities to gain greater, useful insights on their customers and build upon their relatively limited data via consumer data exchange, wherein upon sharing/merging/exchanging customer data, businesses can perform analysis to improve their business performance, and provides an example wherein original data may consist of a list of consumers, which can be enriched with the consumers' transaction history, search history, etc. via data exchange with other entities that own such information.

U.S. Patent Application Publication No. 2010/0262497 for “System and Methods for Controlling Bidding on Online Advertising Campaigns” by inventor Karlsson, filed Apr. 10, 2009, describes a system for managing bid prices of an online advertising campaign. The system includes a memory storing instructions for adjusting bid prices, and a campaign controller for generating a nominal bid price and a perturbation parameter, based on an ad request received from an advertiser. The system further includes an engine for generating a perturbed bid price based on the nominal bid price and the perturbation parameter, according to the instructions stored in the memory. The system further includes a serving unit for serving an ad impression based on the perturbed bid price. Also discloses that advertisers can bid on desired online ad delivery for their ad campaigns, describes management of the bidding process by managing and adjusting the bid price and describes systems and methods for a biddable multidimensional marketplace for advertising.

European Patent Application Publication No. 2063387 for “Systems and methods for a biddable multidimensional marketplace for advertising on a wireless communication device” by inventors Maggenti, et al., filed Mar. 31, 2008, describes providing targeted advertisements via mobile devices, and systems, methods and apparatus for a multidimensional bidding marketplace for providing advertising content to wireless devices. In particular, aspects allows advertising providers, to define and/or identify a one or more wireless device-based transient factors from a plurality of factors, which serve to define a targeted advertising audience and to bid on advertising based on the selected or identified transient factors.

European Patent Application No. 2076877 (also published as U.S. Patent Application Publication No. 2008/0103795) for “Lightweight and heavyweight interfaces to federated advertising marketplace” by inventors Biggs, et al., filed Oct. 18, 2007, describes a multi-party advertising exchange including advertising and publishing entities from different advertising networks, the invention provides architectures for an online advertising marketplace that range from lightweight to heavyweight implementations. A lightweight client side implementation of an interface includes centralized processing and storage of federated advertising marketplace data by centralized servers or services. A heavyweight client side implementation of an interface for advertising entities includes providing a peer instance of a federated advertising exchange application or set of processes is provided to each advertising entity as an interface for advertising entities where processing and storage are performed locally to each peer instance. Distributed advertising data can be replicated or synchronized with other peer instances.

U.S. Pat. No. 8,224,725 for “Escrowing digital property in a secure information vault” by inventors Grim, et al., filed Sep. 15, 2005, describes that data can be escrowed by receiving escrow parameters including a condition(s) for releasing the escrowed data, and an escrow recipient. An escrow contract is then created based upon the specified escrow parameters. The escrowing further includes storing the digital data in a secure information vault, and storing the escrow contract, along with a pointer to the stored data, in a database. When the condition has been satisfied, the data is released to the escrow recipient. The condition(s) for release can be a payment sum, a date, an indication from a depositor, a trustee or a vault administrator, and/or fulfillment of another escrow contract; also describes keeping data secure and releasing data to certain parties upon satisfaction of certain criteria.

U.S. Pat. No. 8,285,610 for “System and method of determining the quality of enhanced transaction data” by inventors Engle, et al., filed Mar. 26, 2009, describes “enhanced data”, non-financial data beyond the primary transaction data and includes invoice level and line item details (for examples see background section) which is collected at the merchant and delivered to a financial service network.

U.S. Patent Application Publication No. 2011/0264497 for “Systems and Methods to Transfer Tax Credits” by inventor Clyne, filed Apr. 25, 2011, includes disclosure for a list of references describing acquiring consumer purchase data.

U.S. Patent Application Publication No. 2011/0264567 for “Systems and Methods to Provide Data Services” by inventor Clyne, filed Apr. 25, 2011, describes providing access to data of diverse sources in general, and more particularly, transaction data, such as records of payment made via credit cards, debit cards, prepaid cards, etc., and/or information based on or relevant to the transaction data; also describes that transaction data can be used for various purposes and that transaction data or information derived from transaction data may be provided to third parties.

U.S. Patent Application Publication No. 2012/0066064 for “Systems and Methods to Provide Real-Time Offers via a Cooperative Database” by inventors Yoder, et al., filed Sep. 2, 2011, describes a computing apparatus is configured to: store transaction data recording transactions processed by a transaction handler; organize third party data according to community, where the third party data includes first data received from a first plurality of entities of a first community and second data received from a second plurality of entities of a second community; and responsive to a request from a merchant in the second community, present an offer of the merchant in the second community to users identified via the transaction data and the first data received from the first plurality of entities of the first community. In one embodiment, the first data provides permission from the merchant in the first community to allow the merchant in the second community to use intelligence information of the first community to identify users for targeting offers from the merchant in the second community.

U.S. Patent Application Publication No. 2012/0054189 for “User List Identification” by inventors Moonka, et al., filed Aug. 30, 2011, describes systems, methods, computer program products are provided for presenting content. An example computer implemented method includes identifying, by a data exchange engine executing on one or more processors, one or more user lists based on owned or permissioned data, each user list including a unique identifier; associating metadata with each user list including data describing a category for the user list, population data describing statistical or inferred data concerning a list or members in a given user list and subscription data including data concerning use of a given user list; storing in a searchable database a user list identifier and the associated metadata; and publishing for potential subscribers a list of the user lists including providing an interface that includes for each user list the unique identifier and the associated metadata.

U.S. Pat. No. 6,850,900 for “Full service secure commercial electronic marketplace” by inventors Hare, et al., filed Jun. 19, 2000, describes an electronic marketplace, and in particular to a full service secure commercial electronic marketplace which generically organizes, stores, updates, and distributes product information from a plurality of suppliers to facilitate multiple levels of sourcing, including contract and off-contract purchasing between the suppliers and a plurality of buyers.

None of the prior art references discloses the systems and methods of the present invention managing signals by signal owners or signal sellers, either in their interactions directly with signal buyers and/or within a signals marketplace for value-based exchange of signals information between buyers and sellers, while ensuring protection of the underlying data represented by the signals; or pricing data signals based upon value derived from the use of data signals as observed from consumer behavior; or for maintaining data in a federated model in control of the data owner; or for allowing signal owners to set rules and parameters for the release of information to approved buyers; or for consumers to permission use of signals and other data taken by third parties through observations. Thus, the creation and management of signals by signal owners is important for providing secure, private and controlled release of information for value that is determined by a structured and rules-based management for signals.

### SUMMARY OF THE INVENTION

The present invention relates to methods and systems to perform access management for signals or indicators, wherein the signals are provided by signal sellers for distribution and sale to signal buyers based upon agreements having parameters and rules created by signal sellers for automatically governing signal access management within a signals marketplace. More particularly, the present invention relates to methods and systems for gaining access to signals based upon rules, policies, exclusions, agreements, price, reputation, location, and combinations that govern signals access management. Signals access management is provided across a multiplicity of signal marketplace participants and agents of participants.

The distributed signals are constructed by signal sellers by transforming raw data into signals or indicators, which facilitate buying and selling distributed information through these signals or indicators without disclosing the underlying data. The signals are derived from data sources and abstracted to protect the underlying data. Signals are constructed in such a way that they protect the underlying data, but have consistency and relevance toward a given objective. Signal owners or sellers first convert data into a “signal” or indicator, the construction of the signal is in the control of the data owner, different signal constructs will have relevance toward different objectives and signal buyers. The signal or indicator construct allows the signal seller to abstract the underlying data without being or disclosing the actual data itself, i.e., the signal functions like metadata. The economic value of the signal depends on the price each buyer is willing to pay, which depends on the value that the signal has toward a given objective. The virtual marketplace brings buyers and sellers of signals together and communicates the history of signal effectiveness for each objective. Sellers of signals define rules governing how to sell signals directly to buyers and/or based upon virtual marketplace historical data, buyer, agreements, price, effectiveness, consumer permissions, local laws, regulation and other rules. Buyers have the opportunity to bid for information within the rules of the marketplace and the rules of the seller. Signals (or indicators of data that do not disclose the data), and the associated virtual marketplace facilitate the discovery of signals for a use, pricing of signals for a defined use, the creation of agreements for use, the regulatory and consumer permission of use, the transmission and tracking during use, the value created after the use, and for the clearing and settlement based upon observations after the use and under the terms of the agreement.

It is an aspect of this invention to provide methods and systems for providing and for managing access to signals that are controlled by agreements having parameters and rules created by their corresponding signal sellers or signal owners. Still another aspect of the invention is to provide signals access management within a virtual marketplace by which a prospective buyers can gain access to the signals. The present invention provides a mechanism for both the buyers and the sellers to create agreements, exchange information within the terms of agreement, ensure regulatory and consumer approval of use, track the performance of the usage, and settle under the terms of the agreement and the observed use.

In the present invention systems and methods, each data owner controls access to signals associated with the data based upon an agreement for a given use for a given price by a given buyer within the rules and terms of the signal exchange agreement, policy, etc. In systems and methods of the present invention, the data owner controls both the creation of the signal, the location of data from which the signal is created, and who has access to the signal, for a given use, for a given price, within a signal exchange agreement and this agreement's associated rules. The constraints within a signal exchange agreement manage use, price, time, volume, third parties, identity translation and other rules are governed by signal access management. According to the present invention, within the signal marketplace, a multitude of agreements are held within a federated data marketplace, each governing the exchange of signals between two or more parties. The agreements within the marketplace are used to manage the access, routing, transformation, security, encryption, receipt, settlement, exceptions, constraints, rules and policies of signal exchange between a multiplicity of buyers, sellers and their approved agents.

Each locally managed signal or indicator requires access management to govern the release of information to a multitude of buyers, which functions as a virtual gatekeeper.

The rules, approved usage, encryption, exceptions, pricing, and constraints are provided within an agreement that is generated and stored in a database associated with at least one server computer within the systems of the present invention. This system control provides for a “ripple effect” that extends through the system via networks into local access control by local computers. In methods of the present invention, each signal owner or seller first creates the parameters and constraints associated with each signal or indicator. Additionally, constraints include data policies and associated form or formats (e.g., German consumer laws or policy may have different restrictions on use which must be accepted by participants when transactions occur within Germany's regulatory purview). At least one policy, constraint, or rule governs each signal based upon the agreement established for the corresponding signal. Thus, each agreement may have multiple policies (policies are separate rule sets that may apply consistently across agreements). Constraints, exceptions, encryption, approved usage and policies are used within various steps of methods according to the present invention, including: signal discovery, signal agreements, signal exchange and signal analytics. For example a policy may to exclude named competitors from perspective buyers, this policy is in place within both the marketplace (which would govern discovery) and within the data or signal sellers locally managed agreement. These policies and constraints restrict the ability for prospective buyers to gain insight of and access to signals (by way of example and not limitation for discovery, use, or pricing) within the federated marketplace.

The present invention further provides for signal or indicator sellers to manage multiple layers of rules and constraints with access management graphic user interfaces (GUIs) which can be located either centrally within the marketplace, or locally within the sellers federated data systems.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram of an embodiment of the invention.

FIG. 2 is a schematic diagram of an embodiment of the invention.

FIG. 3 is a schematic diagram of an embodiment of the invention.

FIG. 4 is a schematic diagram of an embodiment of the invention illustrating components and functions of the signals data marketplace.

FIG. 5 is a schematic diagram of an embodiment of the invention illustrating components and functions relating to signals management.

FIG. 6 is a schematic diagram illustrating a virtualized system for the present invention.

FIG. 7 is another schematic diagram illustrating a virtualized system for the present invention.

FIG. 8 is a schematic diagram of an embodiment of the invention illustrating components and functions of the signals data marketplace, campaigns, and participants in relation to signals management.

FIG. 9 is a flow diagram of an embodiment of the invention illustrating signal lifecycle.

FIG. 10 is a schematic diagram of an embodiment of the invention illustrating components and functions relating to request management for signals.

FIG. 11 is a schematic diagram of an embodiment of the invention illustrating components and functions relating to a use case for batch attribution request for signals management.

FIG. 12 is a graphic user interface (GUI) screen shot illustration of an embodiment of the invention showing inputs for creating agreements and parameters governing signals access and management.

### DETAILED DESCRIPTION

Referring now to the drawings in general, the illustrations are for the purpose of describing a preferred embodiment of the invention and are not intended to limit the invention thereto.

In the present invention systems and methods, each data owner controls access to signals associated with the data based upon an agreement for a given use for a given price within the rules of the agreement, policy, etc. In systems and methods of the present invention, the data owner controls who has access to the signal, for a given use, for a given price, within a set of rules. The constraints managing use, price, and rules are governed by signal access management.

The present invention relates to methods and systems to perform access management for signals or indicators, wherein the signals are provided by signal sellers for distribution and sale to signal buyers based upon agreements having parameters and rules created by signal sellers for automatically governing signal access management within a signals marketplace. More particularly, the present invention relates to methods and systems for gaining access to signals based upon rules, policies, exclusions, agreements, price, reputation, location, and combinations that govern signals access management. Signals access management is provided across a multiplicity of signal marketplace participants and agents of participants.

The distributed signals are constructed by signal sellers by transforming raw data into signals or indicators, which facilitate buying and selling distributed information through these signals or indicators without disclosing the underlying data. The signals are derived from data sources and abstracted to protect the underlying data. Signals are constructed in such a way that they protect the underlying data, but have consistency and relevance toward a given objective. Signal owners or sellers first convert data into a “signal” or indicator, the construction of the signal is in the control of the data owner, different signal constructs will have relevance toward different objectives and signal buyers. The signal or indicator construct allows the signal seller to abstract the underlying data without being or disclosing the actual data itself, i.e., the signal functions like metadata. The economic value of the signal depends on the price each buyer is willing to pay, which depends on the value that the signal has toward a given objective. The virtual marketplace brings buyers and sellers of signals together and communicates the history of signal effectiveness for each objective. Sellers of signals define rules governing how to sell signals directly to buyers and/or based upon virtual marketplace historical data, buyer, agreements, price, effectiveness, consumer permissions, local laws, regulation and other rules. Buyers have the opportunity to bid for information within the rules of the marketplace and the rules of the seller. Signals (or indicators of data that do not disclose the data), and the associated virtual marketplace facilitate the discovery of signals for a use, pricing of signals for a defined use, the creation of agreements for use, the regulatory and consumer permission of use, the transmission and tracking during use, the value created after the use, and for the clearing and settlement based upon observations after the use and under the terms of the agreement.

It is an aspect of this invention to provide methods and systems for providing and for managing access to signals that are controlled by agreements having parameters and rules created by their corresponding signal sellers or signal owners. Still another aspect of the invention is to provide signals access management within a virtual marketplace by which a prospective buyers can gain access to the signals. The present invention provides a mechanism for both the buyers and the sellers to create agreements, exchange information within the terms of agreement, ensure regulatory and consumer approval of use, track the performance of the usage, and settle under the terms of the agreement and the observed use.

In the present invention systems and methods, each data owner controls access to signals associated with the data based upon an agreement for a given use for a given price by a given buyer within the rules and terms of the signal exchange agreement, policy, etc. In systems and methods of the present invention, the data owner controls both the creation of the signal, the location of data from which the signal is created, and who has access to the signal, for a given use, for a given price, within a signal exchange agreement and this agreement's associated rules. The constraints within a signal exchange agreement manage use, price, time, volume, third parties, identity translation and other rules are governed by signal access management. According to the present invention, within the signal marketplace, a multitude of agreements are held within a federated data marketplace, each governing the exchange of signals between two or more parties. The agreements within the marketplace are used to manage the access, routing, transformation, security, encryption, receipt, settlement, exceptions, constraints, rules and policies of signal exchange between a multiplicity of buyers, sellers and their approved agents.

Each locally managed signal or indicator requires access management to govern the release of information to a multitude of buyers, which functions as a virtual gatekeeper.

The rules, approved usage, encryption, exceptions, pricing, and constraints are provided within an agreement that is generated and stored in a database associated with at least one server computer within the systems of the present invention. This system control provides for a “ripple effect” that extends through the system via networks into local access control by local computers. In methods of the present invention, each signal owner or seller first creates the parameters and constraints associated with each signal or indicator. Additionally, constraints include data policies and associated form or formats (e.g., German consumer laws or policy may have different restrictions on use which must be accepted by participants when transactions occur within Germany's regulatory purview). At least one policy, constraint, or rule governs each signal based upon the agreement established for the corresponding signal. Thus, each agreement may have multiple policies (policies are separate rule sets that may apply consistently across agreements). Constraints, exceptions, encryption, approved usage and policies are used within various steps of methods according to the present invention, including: signal discovery, signal agreements, signal exchange and signal analytics. For example a policy may to exclude named competitors from perspective buyers, this policy is in place within both the marketplace (which would govern discovery) and within the data or signal sellers locally managed agreement. These policies and constraints restrict the ability for prospective buyers to gain insight of and access to signals (by way of example and not limitation for discovery, use, or pricing) within the federated marketplace.

The present invention further provides for signal or indicator sellers to manage multiple layers of rules and constraints with access management graphic user interfaces (GUIs) which can be located either centrally within the marketplace, or locally within the sellers federated data systems.

The present invention is based upon methods and systems for using, buying and selling distributed data using signals or indicators that represent the data without disclosing the data, and the signal owner managing its proprietary signals. By way of background, creators of signals are the sellers of information. The content of a seller's information based upon an historical interaction with one or more events, objects or activities that correspond to the behavior of a multitude of objects. Sellers of data or information have multiple requests to share their information. Signals or indicators are a mechanism to share derived information without disclosing the raw data. The value of any asset is highly correlated to the price that buyers are willing to pay.

There is a longstanding and unmet need for providing signal management by signal creators (also the signal sellers and/or signal owners) who selectively provide information of interest to signal buyers for defined uses, while protecting the underlying data and maintaining the control of the signal seller through its usage within a network-based, distributed data exchange where economic value of the data, as derived from its use, is the central pricing mechanism within agreements between the sellers and buyers. Nothing in infinite supply can have a price. Data may theoretically have an infinite value, but once it is shared, further dissemination is hard to prevent, thus the value of data quickly diminishes once it is shared. It is an objective of the Signals Exchange Marketplace to create a market for data within a signal or indicator framework, which protects the underlying data that the signals or indicators represent. This signals metaphor allows each signal or indicator provider/owner/seller the ability to construct, control and price their signals and protect further dissemination of both the signals, as well as the underlying data.

The present invention provides a method for managing signals by corresponding signal owners in a virtualized or cloud-based computing system wherein the method steps include: providing a signal index associated with at least one signal corresponding to a behavior of an object and/or an activity and/or an event, wherein the signal index includes a proposed signal value for a predetermined signal use, and wherein the signal index is stored in a memory of a signal owner computer that is constructed and configured for network-based communication with a remote server computer; transmitting the signal index to the remote server computer, which is accessible by distributed signal buyers via the network; delivering signals to the signal buyers; tracking the signals; and monitoring use of the signals for the predetermined signal use by the signal buyers.

Additional steps may include the following: providing a feedback corresponding to the use of the signal, wherein the feedback includes object behavior, or activity, economic measurements, and/or event measurements; automatically adjusting the correlation of the signal(s) based on the feedback; updating the signal index to include the feedback; receiving information from signal buyers confirming receipt of signal, and compliance with the predetermined signal use; automatically correlating the indexed signals to requests of distributed signal buyers.

From the beginning, the signal owner controls how the at least one signal is created, generated and/or constructed; however, for most signals, the at least one signal includes information about object state, activity, behavior recency, behavior frequency, and behavior affinity; and further includes a signal type selected from the group consisting of: state signals, event signals, activity signals, behavior signals, relational signals, location signals, loyalty signals, purchase signals, social signals, and combinations thereof. Significantly, the signal owner has further steps in managing its signals, including: retaining control of signal data within a defined use of the signal by a registered buyer; selectively sharing information with buyers; defining use and an agreement to report on a result of use with a registered buyer or counterparty; releasing signal data to a registered buyer based upon the agreement; monitoring performance of the at least one signal compared with a corresponding objective; generating a unique identifier associated with each signal owner for exchange with the signal buyers; the signal owner limiting signal availability to signal buyers and/or to a signal marketplace based upon a rules engine that enforces limitations by any party in a transaction for the signal(s), wherein the rules engine includes rules regarding: buyer identity, campaign type, signal requested, price, redemption signal type, purchase quantity, past performance of signal, past performance of campaign type, past performance of buyer, and combinations thereof; linking the indexed signals to relational databases; and each signal owner tracking agreements for buying and selling signals.

For the signal owner's management of the signals, preferably each of the signals is indexed in the centralized database based upon ownership, object relevance, behavior relevance, historical usage, performance, and correlation to other signals and data, wherein the value is automatically generated by a remote server computer associated with the remote database, based upon at least two factors associated with the value, and wherein the value includes relevance to a signal buyer and a buyer objective. By way of example and not limitation, the relevance to the signal buyer is based upon at least one objective, with the economic value of the signal based upon the measured performance of at least one signal toward at least one objective by the buyer. Preferably, the at least two factors used for generating a signal value are selected from: predictive accuracy, fidelity, relevance to an objective, near-real-timeliness, frequency, recency, state of an object, relationship of the source of the signal, reputation of the signal, reputation of the seller, affinity to a target, and/or usefulness to an objective. By way of example and not limitation, the relevance of a signal to the signal buyer based upon at least one objective may include marketing and/or advertising. In a non-advertising use, the exchange of data within the data marketplace can also take place between a buyer and a seller, without the participation of other entities such as a publisher, retailer or consumer. For example, a farmer has created data on the average yield of corn per acre during the harvesting of the corn crop. The farmer also has data on the type of corn seed used in the field, and the precipitation (total rainfall) on each acre he manages. A signal buyer seeks the average yield of that farmer's seed by acre, by precipitation. The farmer will sell the data through a signal agreement. The signal agreement will specify the terms by which the signal can be used, price, time, retention and other terms necessary.

The methods for signal management by the signal owner may further include additional steps including: aggregating the signals; creating a new signal or a synthetic signal from one or more signals from at least one source; linking the indexed signals to relational databases, wherein the signals are locally indexed by each signal owner and/or each seller associated with the signals; the virtual marketplace server computer and/or the owners creating and tracking their corresponding indexed signals; updating the remote and centralized indices of signals; and/or tracking agreements for buying and selling signals.

In another embodiment of a method for managing signals by signal owners, the method steps include: constructing at least one signal and saving the signal(s) to a signal owner computer, wherein the signal owner controls how the at least one signal is created, generated and/or constructed and how the at least one signal is used by the buyer; generating a signal index and listing the index in a centralized database; generating a signal value based upon at least two factors associated with each value, the at least two factors selected from the group consisting of: predictive accuracy, fidelity, relevance to an objective, near-real-timeliness, frequency, recency, relationship of the source of the signal, reputation of the signal, reputation of the seller, affinity to a target, usefulness to an objective, and combinations thereof.

Additional steps may further include: automatically updating the listed index and/or creating new listings; receiving a defined use and an agreement to report on a result of use by a registered buyer with the signal owner computer; releasing signal data to a registered buyer based upon the agreement between the signal owner and the registered buyer; monitoring performance of the at least one signal compared with a corresponding objective; the signal seller providing each of the signals with a unique identifier associated with each signal owner/seller for exchange with a buyer via the marketplace; automatically determining a relevance to an objective for the at least one signal based on comparison with consumer feedback and consumer behavior; limiting signal availability based upon a rules engine that automatically considers buyer identity, campaign type, signal requested, price, redemption signal type, purchase quantity, past performance of signal, past performance of campaign type, past performance of buyer, and combinations thereof; automatically correlating how the value of the information decays over time and with respect to relevance to the objective; generating a value of signal relevance to the objective based upon consumer feedback, buyer behavior, and/or consumer reputation; receiving feedback from the buyer regarding qualities of relevance, correlation, and/or strength of the at least one signal; and/or receiving inputs from third party observers that inform the efficacy of signal use and correlation across a multitude of participants and multitude of signal uses.

The present invention system for managing signals by corresponding signal owners in a virtualized or cloud-based computing environment includes the following components and their relationships: a remote server computer constructed and configured for network-based communication with at least one signal owner computer and at least one signal buyer computer; at least one signal associated with a behavior or state of an object and/or an activity and/or an event; a signal index associated with the at least one signal, which is stored in a memory of the signal owner computer; and a proposed signal value for a predetermined signal use corresponding to the at least one signal, thereby delivering signals to the signal buyers, tracking the signals, and monitoring use of the signals for the predetermined signal use by the signal buyers. Additionally, the signals are indexed, abstracted and/or anonymized from their data source to protect the identity of the signal owner. Also, preferably, the remote server computer is constructed and configured to receive inputs via a communications network from third party observers that inform the efficacy of signal use and correlation across a multitude of participants and multitude of signal uses.

In another embodiment of systems for managing signals by signal owners includes engagement or interaction with a signals marketplace in a virtualized computer network for generating signals from distributed data sources controlled by a multiplicity of owners and further includes at least the following components and their relationships with each other: a remote server computer constructed and configured in network-based communication with a centralized database further comprising at least one index for signals data, and operable to automatically generate an assigned value corresponding to each unique signal created by a signal seller within a remote index of signals data; wherein the remote indexed signals data are generated from remote structured and unstructured data. receiving at least one signal from a first data source and at least one signal from a second data source, wherein the marketplace registers remote signals, which originate from different distributed data sources controlled by different owners into a centralized database or signals index; wherein each of the registered signals has a corresponding assigned value stored in the central database and associated with its indexed corresponding remote signal; and, wherein each assigned value is based on at least two factors is dependent upon a signal source value and a buyer objective. Preferably, the signals marketplace system automatically recommends signals, and the price for a given usage for both signal buyers signal sellers or signal owners. Additionally or alternatively, the recommended pricing is automatically generated based upon a number of factors, including relevance to an objective, fidelity, near-real-timeliness or recency, affinity, predictive accuracy, and combinations thereof, and/or is negotiated in a bid-response exchange between the owners and buyers.

In the virtual marketplace, purchases of the owners' signals are tracked by the owners or sellers, within the remote server computer, and in the signals marketplace, which automatically tracks the signals data through its function of transferring signal information between buyer and seller within active agreements, and monitoring feedback on signal performance through observation of events, behaviors, environment and states of objects and objectives. The marketplace uses this feedback to update directories, indices, pricing, history, agreements, and correlations to an objective. Also preferably, the signals marketplace centralized server computer automatically tracks and manages signal and participant reputation for communication to other marketplace participants. The signals and their corresponding owners, as well as buyers, brokers, publishers, observers and other participants are registered and registration information is stored in the centralized database associated with the virtual marketplace remote server computer, and the registration information is stored in a shared directory associated with the centralized database.

The present invention also provides an embodiment including a method for creating and using a virtual marketplace for valuing and selling signals generated from distributed data sources that are controlled by a multiplicity of owners, the method steps including: providing at least one signal from a first data source and at least one signal from a second data source to a remote server computer for a signal marketplace or exchange; wherein the signals originate from different distributed data sources controlled by different owners and the signals are indexed and listed in a centralized database and each of the indexed signals is linked to corresponding relational databases; and, wherein a value for each centralized indexed signal is automatically generated by the remote server computer associated with the seller where terms of use have been agreed. The value of the signals is controlled by the seller and based upon at least two factors associated with each value, the at least two factors selected from the group consisting of: event, object state, change in state, behavior of an object, relationship to another object, relationship to a behavior, economic indicators, relevance to an objective, near-real-timeliness, frequency, recency, predictive accuracy, fidelity, reputation of the signal, reputation of the seller, affinity to a target, usefulness to an objective, and combinations thereof. Also, in this method embodiment, as with the systems of the present invention, the marketplace provides for participation and compensation of other parties that observe object behavior, object state or are otherwise capable of providing feedback signals corresponding to a state, behavior, activity, and/or an event. This observer feedback informs the agreements, economic value of the signals, object preferences, calculated correlation of signal information, environmental projections and other marketplace functions. The economic value of the observation can be calculated by the marketplace, and these observation feedback signals can be indexed and purchased within the marketplace. Advantageously, the listed index provides for automated matching with buyer candidates having corresponding objectives for buying signals and signals data, and wherein the objectives include consumer state, events and behavior(s). Additional method steps include: the step of automatically updating the listed index and/or creating new listings; receiving a defined use and an agreement to report on a result of use by a registered buyer with the server computer; releasing signal data to a registered buyer based upon the agreement between the signal owner and the registered buyer; monitoring performance of the at least one signal compared with a corresponding objective; automatically determining a relevance to an objective for the at least one signal based on comparison with consumer feedback and consumer behavior; and/or limiting signal availability based upon a rules engine that automatically considers buyer agreement, identity, campaign type, signal requested, price, redemption signal type, purchase quantity, past performance of signal, past performance of campaign type, past performance of buyer; automatically correlating how the value of the information decays over time and with respect to relevance to the objective; and combinations thereof.

According to the present invention, the signal owner controls how the at least one signal is created, generated and/or constructed and how the at least one signal is used by the buyer. To facilitate the virtual marketplace or exchange between signal sellers and signal buyers, preferably the at least one signal includes a signal type selected from the group consisting of: event signals, activity signals, behavior signals, performance signals, relational signals, location signals, loyalty signals, purchase signals, social signals, and combinations thereof.

Methods of the present invention further include the step of generating a value of signal relevant to an objective based upon consumer feedback, consumer behavior and/or consumer reputation; and, more particularly, wherein the value of the at least one signal depends upon the time of the at least one signal from an event occurrence, and wherein the value of the at least one signal decays over time. Also, the methods include the step of automatically correlating how the value of the information decays over time and with respect to relevance to the objective.

Preferably, the virtual marketplace or exchange server computer receives feedback from the buyers and observers regarding qualities of relevance, correlation, and/or strength of each of the at least one signal. In preferred embodiments of the present invention, a signal quality and a signal reputation are automatically generated by the virtual marketplace based upon an assessment of signal performance compared with an objective and/or based on the feedback received.

The present invention including signals management within the context of a virtual data marketplace for signals is built on the framework of creating signals or indicators by their corresponding signal owners or signal sellers, the method steps performed by a signal owner include: constructing at least one signal associated with a behavior of an object and/or an activity and/or an event associated with the object in a signal owner computer that is constructed and configured for network-based communication with a remote server computer, wherein the at least one signal based upon at least two factors associated with each value, the at least two factors selected from the group consisting of: event, object state, change in state, behavior of an object, relationship to another object, relationship to a behavior, economic indicators, relevance to an objective, near-real-timeliness, frequency, recency, predictive accuracy, fidelity, reputation of the signal, reputation of the seller, affinity to a target, usefulness to an objective, and combinations thereof; creating agreement terms for managing access to the at least one signal; generating a first value for each of the at least one signal; and tracking usage of the at least one signal. Also, the at least one signal provides a feedback corresponding to the behavior, state, activity, and/or the event. Additional steps include indexing the at least one signal; listing the indexed signals in a remote database associated with the remote server computer; communicating the remote index signal to the centralized data marketplace signal index, wherein the centralized signal index listing provides for automated matching with buyer candidates having corresponding objectives for buying signals and signals data, wherein the objectives include consumer behavior(s); and updating the listing of the indexed signals by the signal seller or signal owner. The methods and systems of the present invention provide for automated signals access management with the agreement terms adopted by both signal buyers and signal sellers; the agreement governs the exchange of signals for all participants in the signal marketplace.

The at least one signal includes a signal type selected from the group consisting of: event signals, activity signals, behavior signals, relational signals, location signals, loyalty signals, purchase signals, social signals, and combinations thereof. Signals are generated or constructed from both structured and unstructured data. Significantly, each signal owner controls how the at least one signal is created, generated and/or constructed; in embodiments of the present invention, methods of the present invention provide steps wherein signals or indicators are created by the signal owner transforming its own data into the signals or indicators through steps of automatically organizing structured data and unstructured data by a correlation engine. In constructing the at least one signal or indicator, preferably the signal seller (or its system and seller correlation engine) automatically determines a relevance to an objective from historical performance and including external observations and feedback on object state, activity or behavior.

While the definition and construction of the signal is at the discretion of the Seller, generally signals conform to a common signal structure whose elements are named and formatted to marketplace conventions for the purpose of creating a common taxonomy for exchange of signal information. In the case of a signal exchange within a signals marketplace, but also for exchange outside of a marketplace, the signal structure provides for secure and reliable transportation and translation of an information payload contained with a signal. The signal construct defines the source, the destination, the delivery channel, the method for securing the data, the agreement under which the data is exchanged, a transaction identifier, a transaction time, information necessary to confirm receipt, template which describes the message type, and the payload of the message. Sellers and buyers use the signals construct to create, register, publish, discover, assess, sell, manage, and measure data exchange according to the systems and methods of the present invention. Signal types include both buyer-initiated and seller-initiated signals; some examples follow for illustration purposes, but are not intended to limit the claimed invention thereto.

Buyer Initiated Behavior Signal (BIBS). Behavior signals are published by sellers which observe object behavior. For a given buyer initiated behavior signal, the buyer of a behavior signal requests behavior signal from seller for a given event, object or category of objects. The content of the seller's signal is based upon an historical interaction with one or more events, objects or activities that correspond to the behavior of an object. To obtain the seller's signal, the buyer must provide a reference point for the seller to create the behavior signal. In this model it is the request of the buyer triggers the exchange of data. For a given reference point, the seller's signal describes a behavior such and such information as the recency and the frequency of the behavior. By way of example and not limitation, a behavior name is illustrated by “Travel-To [Variable]”. The buyer initiates the request and seeds the reference point variable for the signal. Each buyer could pay a different price depending on the value they derive from the signal.

Buyer Initiated Event Signal (BIES). Event signals are published by sellers which observe events. For a given buyer initiated event signal, the buyer of an event signal requests objects, or categories of objects from seller that have a relationship to a given event. The content of the seller's signal is based upon an historical interaction with one or more events, objects or activities that correspond to an event. To obtain the seller's signal, the buyer must provide a reference point for the seller to create the event signal. In this model it is the request of the buyer triggers the exchange of data. A signal request is initiated by the buyer asking the seller if a given reference event has occurred. The signal response can contain information on the event, objects within the event, recency, frequency, location, as well as specifics surrounding the event. By way of example and not limitation, consider “movie purchases in Cincinnati Ohio in last five minutes” as a signal request of this type. Each buyer could pay a different price depending on the value they derive from the signal.

Seller Initiated Behavior Signal (SIBS). In this case the seller is initiating (or publishing) that a behavior has occurred. The content of the seller's signal is based upon a current or historical interaction with one or more events, objects or activities which correspond to the behavior of an object. The signals can be published to one or more buyers, and prospective buyers as the activity occurs. Each buyer could pay a different price depending on the value they derive from the signal. By way of example and not limitation, consider “consumer [CONSUMER_NAME] is shopping in [Location]” as a signal.

Seller Initiated Event Signal (SIES). Seller is publishing an event to one or more buyers. The content of the seller's signal is based upon a current or historical interaction with one or more events, objects or activities, which correspond to the behavior of an object. From a software design perspective, this model is consistent with software based publish/subscribe paradigm. Within commerce signals buyers “subscribe” to an event made known by the seller. Each buyer could pay a different price depending on the value they derive from the signal. The seller initiates the signal, and can communicate specifics about the event. By way of example and not limitation, consider “consumer [CONSUMER_NAME] purchased movie ticket” as a signal.

The signals may be directly derived, constructed, or generated from signal owner raw data and/or synthetic signals may be constructed from at least one signal or a multiplicity of signals, i.e., one or more signals are used to construct additional signals, so the synthetic signals are not directly associated with the underlying raw data. Once again, signals or indicators according to the present invention are generated or constructed from both structured and unstructured data of the signal owner. Similarly, a consensus signal or a generalized signal from one or more signals. Note that the method steps of the present invention are made for a multiplicity of signals and corresponding signal owners, in particular in the case of distribution in the context of a virtual marketplace or exchange for signals.

Preferably, after constructing signals, their distribution or sale to buyers is controlled by the signal owner and rules governing seller signals or owner signals that provide for limiting signal availability based upon a rules engine that automatically considers buyer identity, campaign type, signal requested, price, redemption signal type, purchase quantity, past performance of signal, past performance of campaign type, past performance of buyer, and combinations thereof. The rules engine resides within a remote computer of the signal seller and is communicated through a distributed network, either directly and/or within a virtual marketplace having a centralized rules engine governing the management of the exchange of signals for a multiplicity of signal sellers and signal buyers.

Signal value cannot be established conclusively independently of a signal buyer's objective. Additionally the value of any of the signals depends upon signal relevance to the objective based upon a multiplicity of factors, including feedback such as time from last observation and/or interaction, effectiveness of consumer interaction, depth of interaction, consumer feedback, buyer behavior, and/or consumer reputation. The signal seller correlation engines provide options for automatically correlating how the signals or indicators relate to data held within the signal seller to data external to the signal seller. The present invention also provides an embodiment including a method for adjusting the correlation of data with time and with respect to relevance to the objective(s) of buyers. Significantly, regardless of the objectives, generally the value of the signal(s) depends upon the time of the signal construction from an event occurrence, wherein the value of the signal decays over time. Also, the present invention provides for the economic value of the signal to decay over time. By way of example and not limitation, consider a signal “Consumer [ID] Purchased Movie Ticket at TIME”. This signal has relevance to a buyer's objective, which is dependent on time since the observation. In other words a signal has a higher relevance if it is one second old, and a lesser relevance as time progresses. The economic value of a signal is in proportion to its relevance, hence the value of the signal is also higher if the signal is one second old, and a lesser value as time progresses.

Feedback is a form of signal sourced from observers of objects. Observers typically have no need to maintain historical information, but rather report on current object state or activity. By way of example and not limitation, consider a Wi-Fi hotspot at LOCATION that has a current request for access from COMPUTER_ID. If the objective of a signal buyer was for COMPUTER_ID presence at LOCATION, then this observation is relevant to the buyer. Furthermore, the process of receiving feedback from observers, pertaining to object state, activity, performance and behavior, provides a mechanism to assess and adjust performance of marketplace participants, marketplace systems, signals and campaigns operating within a federated data marketplace. And so evolving the at least one signal based upon the feedback received is an additional step in methods of the present invention. Additionally, a signal quality and a signal reputation is automatically generated (by the correlation engine of the signal seller and/or by the signal marketplace or signal exchange) based upon an assessment of signal feedback. The signal feedback may provide information useful for evaluating performance of the signal compared with the buyer's objectives; the virtual marketplace will determine what feedback is relevant toward any objective. By way of example, a correlation engine is described within U.S. Pat. No. 5,504,839 for “Processor and processing element for use in a neural network” by inventor Mobus, filed Aug. 29, 1994, which is incorporated herein by reference in its entirety.

The present invention provides methods for creating signals or indicators by corresponding signal owners, the method steps performed by a signal owner includes: constructing at least one signal associated with a behavior of an object and/or an activity and/or an event associated with the object in a signal owner computer that is constructed and configured for network-based communication with a remote server computer, wherein the value of the signals is controlled by the seller and based upon at least two factors associated with each value, the at least two factors selected from the group consisting of: event, object state, change in state, behavior of an object, relationship to another object, relationship to a behavior, economic indicators, relevance to an objective, near-real-timeliness, frequency, recency, predictive accuracy, fidelity, reputation of the signal, reputation of the seller, affinity to a target, usefulness to an objective, and combinations thereof; generating a first value for each of the at least one signal; and tracking usage of the at least one signal. Also, the at least one signal provides a feedback corresponding to the behavior, activity, and/or the event. Additional steps include indexing the at least one signal; listing the indexed signals in a remote database associated with the remote server computer, communicating the remote index to the centralized data marketplace signal index, wherein the centralized signal index listing provides for automated matching with buyer candidates having corresponding objectives for buying signals and signals data, wherein the objectives include consumer behavior(s), events, object states, object performance; and updating the listing of the remote and centralized indices by the signal seller or signal owner.

The content of the seller's signal is based upon the seller's interaction with one or more events, objects or activities. Signals are generated or constructed from both structured and unstructured data, which contain records of interaction. Significantly, each signal owner controls how the at least one signal is created, generated and/or constructed; in embodiments of the present invention, methods of the present invention provide steps wherein signals or indicators are created by the signal owner transforming its own data into the signals or indicators through steps of automatically organizing structured data and unstructured data by a correlation engine. While the definition and construction of the signal is at the discretion of the Seller, generally signals conform to a common signal structure whose elements are named and formatted to marketplace conventions for the purpose of creating a common taxonomy for publishing, discover and exchange of signal information. By way of example and not limitation, the taxonomy of the at least one signal includes a signal type selected from the group consisting of: state signals, event signals, activity signals, behavior signals, relational signals, location signals, loyalty signals, purchase signals, social signals, and combinations thereof.

The present invention provides for the signal owner selectively sharing signals information with signal buyers in a virtual marketplace or exchange, wherein the signals information includes a unique identifier associating each signal transmitted by an owner and/or signal seller for exchange with a signal buyer and/or signal data marketplace and agreement within which the data exchange was governed. Preferably, the information shared provides privacy protection for the signal owner. Furthermore, each signal includes and defines the source, the destination, the delivery channel, the method for securing the data, the agreement under which the data is exchanged, a transaction identifier, a transaction time, information necessary to confirm receipt, template which describes the message type, and the payload of the message. In any case, the signals or indicators constructed by the signal seller (signal owner) provide the seller with a mechanism to protect the underlying data from which the signals or indicators are derived. Also, in preferred embodiments, additional privacy protection may be provided by at least one of: screening, anonymizing, and/or using hashed values. For example with hashed values, methods provide for matching credit card objects with MD5 hash of a credit card number allowing signal sellers to identify behavior on the match of hash values versus the match of actual credit card numbers; importantly the MD5 hash cannot be easily reversed (except by NSA). Both entities or parties to the transaction are doing consistent hash, but neither one disclose a number. The same methods and systems are used with email hash; it confirms the match, but only discloses the encrypted information.

Systems and methods of the present invention provide for releasing signal data to a registered buyer based upon an agreement between the signal owner and the registered buyer. Before an agreement is generated, the signal seller retains control of the signal data until after receiving a defined use by a registered buyer, which provides one of the key terms for the agreement. Preferably, the agreement also provides requirements for feedback and/or measurement of objective, such as by way of example and not limitation, to report on a result of use by a registered buyer. Also, the release of the signal data is can be either based upon an observance by the seller or by a request of the buyer. In another embodiment, the release of signal data is based upon a trigger. Preferably, the release of signal data or signals to registered buyer(s) is automatic based upon detection of the trigger.

The systems and methods of the present invention for signals management also provide for automatically confirming receipt of the at least one signal by a destination or signal buyer(s); this step is achieved by automated messaging generated from the buyer computer and communicated automatically through the network to the seller computer directly and/or to the signal marketplace server computer for tracking of all signals distribution based upon unique signal identifiers and the agreements between signal sellers and signal buyers for predetermined uses of the signals.

As set forth in the foregoing, the construction of signals is provided for use between signal sellers and signal buyers via the virtual marketplace through a network for communication between their distributed computers and a remote server computer associated with the virtual marketplace for signals data. The present invention further provides methods and systems for establishing and using a virtual marketplace for value-based exchange of those constructed signals, wherein the value of the signals is determined in the context of willing signal buyers and signal sellers for the signals. The signals of the present invention are derived from data sources that are owned by a multiplicity of entities and/or individuals, and the signals are abstracted from distributed information and data associated with the multiplicity of entities and/or individuals to protect the underlying information and data. Each entity or individual that sells signals data in the virtual marketplace first converts or transforms their unique raw data (or underlying data) into a “signal” or signals, which are indicators associated with object behavior as observed by their respective owners. The value of any signal cannot be determined separate from one or more buyers, their objectives, and the corresponding use of the signals toward those objectives. Signal sellers create and define rules in which to sell signals. Rules can be based upon requestor, usage, object, behavior, performance, reputation or any other attribute available in the market. By way of example and not limitation, Barclays Bank will only allow consumer travel signals to be used by approved vendors and with explicit consumer permission for hotel reservation use. Buyers have the opportunity to request access to signals within the rules of the marketplace seller, consumer and other regulatory authority. Sellers may choose to accept requests within the terms of an agreement, which is maintained in the marketplace or directly between the 2 parties. In the case of a signals marketplace or exchange for the signals, the marketplace centralized server computer retains the information on the agreement, signal requests, signal exchanges, feedback, historical data, buyer, seller, seller reputation, signal reputation, price, effectiveness, rules, constraints, and combinations thereof.

According to the present invention, signal creators (signal sellers) or signal owners retain control of their respective data and the signals constructed therefrom, until a registered buyer defines use of the signals, agrees to report on result (by way of example and not limitation, reports on effectiveness for a given use) and other terms, and an agreement is created between buyer and seller. This method for creating and using signals or indicators establishes control, value, and price for those signals between the signal seller and signal buyer(s), and/or the signal sellers and signal buyers who are the participants in a virtual marketplace or signals exchange. The signal supplier or signal seller (or signal owner) controls how each signal is constructed or generated; the underlying data or information owned by the signal seller may be reconstructed or regenerated into more than one signal for use by third parties for different purposes. Marketplace rules govern construction, transmission and tracking of signal information and the associated object throughout their defined use; this allows signals to be correlated to object behavior. Tying signal performance to object behavior and object events subsequently provides for measurement of value and subsequent market based pricing of signals within the virtual marketplace. Object behavior may take the form of feedback from parties, which are external to any given agreement between buyer and seller. This object behavior obtained from external third party observers inform and correct the correlation of signals to objects and behavior within the marketplace. Importantly this correlation is external to information available to either buyer or seller independently. Third party observers thus participate in the marketplace to provide feedback on objects, which may be covered within a multitude of agreements between a multitude of sellers and buyers. Thus the present invention, provides for the interaction of third party observers across the entire marketplace participants. The signal construct defines the source, the destination, the delivery channel, the method for securing the data, the agreement under which the data is exchanged, a transaction identifier, a transaction time, information necessary to confirm receipt, template which describes the message type, and the payload of the message. The construction of a signal by a signal seller will have varying degrees of relevance to any given signal buyer and that buyer's objective, thus the value of the information and data, as well as the signals generated therefrom, will vary with its correlation and fidelity. This provides a natural feedback loop in the virtual marketplace or exchange. Signals that have poor fidelity or poor correlation with an objective will have poor performance, and thus a correspondingly poor price.

Signal sellers have minimal insight into prospective buyers, and the value of their signals in any given context. Visibility is further limited into competing data. For example, if an advertiser intends to sell hotels to frequent travelers of a predetermined destination, they have the choice of seeking information from flight records, geo location, rental car records, credit card issuers, etc., and combinations thereof. Buyers of information also have interests to optimize price for a given performance or quality of correlation. If a signal buyer could obtain geographic location information for $0.05 with a 70% correlation, it may well be a preferred purchase to flight records, which cost $5.00 and have a 100% correlation. Within a signals advertising application embodiment, the signal marketplace assumes the primary role in directing and optimizing the purchase of signals for targeted advertising, including campaigns across multiple prospective sources, to determine which signals (if any) have relevance to a given advertising campaign, and providing both buyers and sellers with a liquid market in which to exchange, and protect, information, while providing and purchasing use of the signals within the marketplace or exchange. Significantly, a category of signals that represents real time or near real time activity, events, states and behavior have values that decay quickly with time. In this instance a signal that represents an object's activity one second ago has a greater value than the same signal that is one hour old. The signals marketplace enables the transmission of these real time signals within the rules and constraints of the participants, consumers, marketplace and regulatory authorities.

Furthermore, the marketplace for signals includes a signals index for discovery, tracking and comparing signals and their historical value, reputation and performance. Categories or groups of signals by type, behavior, seller, and usage are also provided. By way of example and not limitation, signals include an expression of frequency and relevance toward an input variable (e.g., affinity to a city, type of food, automobiles, sports, etc.). Also, signals responses are based upon the object identifier which the seller uses internally to uniquely identify a given object. By way of example and not limitation, object identifiers include encrypted forms of e-mail address, phone number, location, loyalty card number, etc. Correlation between signals and their performance is represented by the signal pricing and trading (buying/selling) within the virtual marketplace, third party observers, and/or directly between signal sellers and signal buyers. Additionally, initial rating for expected correlation between signals and their performance is provided by the seller. A new signal will have no historical performance and thus buyers will likely minimize their purchase until the performance can be validated.

In the embodiment having a signals marketplace or exchange, the centralized server computer associated with the signals marketplace maintains a master directory of signals and associated correlations in order to facilitate automated signal seller to signal buyer matching. Historical performance of a signal, signal seller and third party observer information may be used to correlate between signals based upon buyer and usage. Additionally, initial rating for expected correlation between signals and their performance is provided by the seller. A new signal will have no historical performance and thus buyers may likely minimize their purchase or until the performance can be validated.

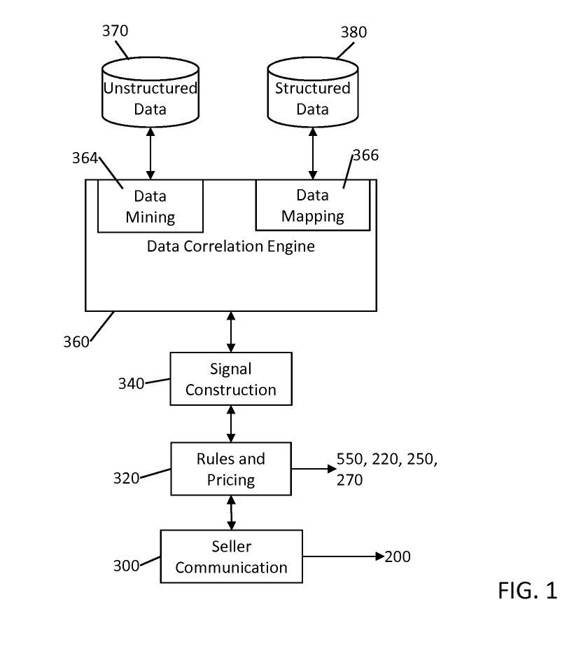

As illustrated in FIG. 1, the flow diagram indicates signal construction or generation method steps. As illustrated in the FIG. 1, the system provides data mining 364 on the unstructured data and data mapping 366 on the structured data. Signals are based on structured 380 and unstructured 370 data. The content of the seller's signal is based upon an historical interaction with one or more events, objects or activities that correspond to the behavior of an object. To obtain the seller's signal, the buyer must provide a reference point for the seller to create a signal. For example, a signal of AFFINITY_TO_CITY may require input of ID, and CITY_NAME. A plane, a phone, a consumer, a computer could all have an affinity to a city. Similarly a phone company, an airline, a rental car company, a bank, a search engine, a restaurant, or similar entity could all have a set of data that would inform the affinity toward a city. The signal seller has multiple options when constructing a signal of “AFFINITY_TO_CITY”, sellers could use consumer billing records, flight records, payment records, location records, in sourcing data for to respond to this request. In order to protect consumer information, the signal seller may use any source of information in constructing a response and a signal response is typically normalized to be between 0 and 1, or otherwise created in a way to abstract the underlying data in a way that makes the signal relevant to a specific request. For example an airline may use flight information to determine that a consumer has traveled to NYC five times in the last year and has set AFFINITY_TO_CITY for New York equal to 0.5. The value of this information is completely dependent on its quantity, accuracy, recency, competing information sources, price and intended use. The marketplace 250 informs the rules and pricing engine 320 of relevant information to set price.

Signal sellers have control over how they sell their signals data within the rules engine 320. These rules can be constructed based on any marketplace attribute. For example, if United Airlines bought signals data within the signal marketplace, or directly from signals seller(s), and receives a response from a signals data seller that is a competing airline for a particular traveler, United Airlines could surmise the this particular traveler uses the competing airline for travel to that city and could thus directly market to the that consumer. In one embodiment of the present invention, the signals data seller rules engine 320 is within the control and ownership of the each signal seller. In this case, the marketplace data is not held centrally; significantly, raw data, signal construction, signal indexing, signal rules, and signal indexing are managed remotely across each data exchange participant. Each participant leverages a common taxonomy for constructing signals, which provides for remote discovery in remote indexes, or centrally when remote indexes are combined or transferred to the common centralized server computer for the signals market. Significantly, this federated model provides for control of the data by the owner, allowing the marketplace to establish linkage to federated data owners, with each data owner in control of rules and parameters for the release of information to approved buyers; allowing the centralized market to manage rules during the exchange and provide for clearing and settlement of federated data (signals) for multiple participants and/or multiple federated data sources which act in concert toward a common objectives, with each participant paid based upon value delivered, observed externally or price agreed to.

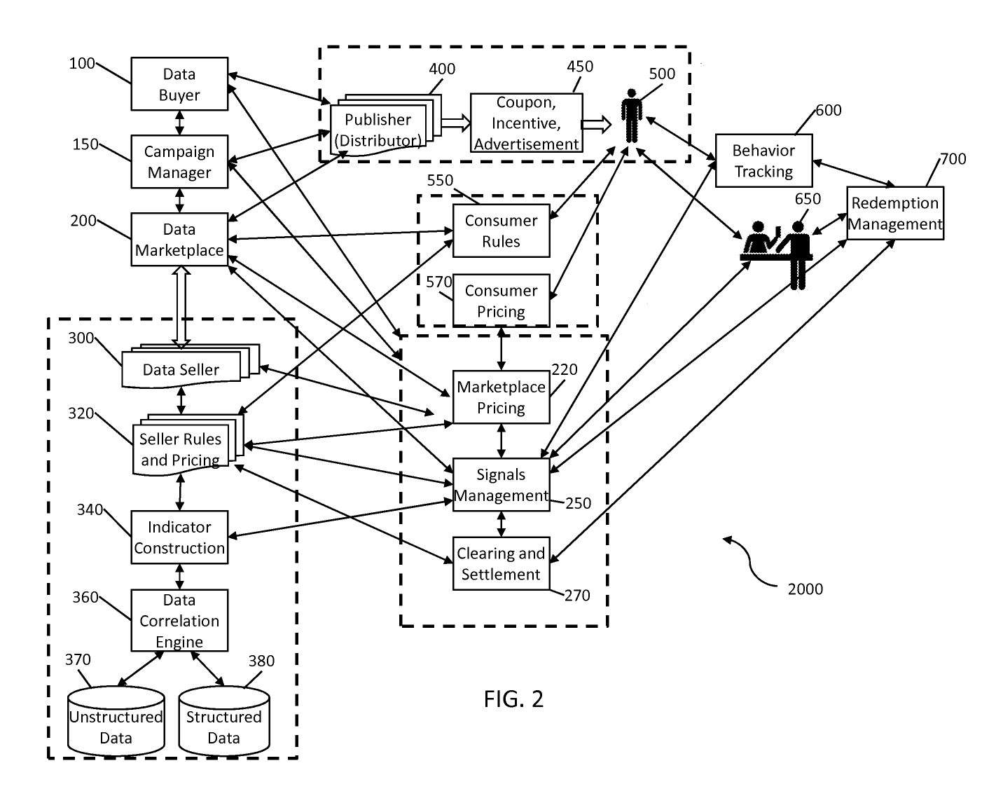

By way of example and not limitation, the signal marketplace rules include registration of participants, construction of signals, management of agreements, enforcement of rules, destruction and safeguarding of data, purchase of signals, use of signals, tracking of signal performance, clearing and settlement, marketplace history, tracking reputation of signals and all participants, involvement of indirect specialists and agents, dispute process, participant responsibilities, and other significant areas. Given that the price of signals is unknown to any given buyer, the prospective buyer must first issue a request for the signal combined with an offer or request for quote to a signal seller. The request for quote contains information necessary for the seller to determine price and establish bid-response communication protocol. Sellers respond with a request for quote (RFQ) response or no response. If there is an RFQ response it can include acceptance or alternate terms. Upon receiving the RFQ response the buyer may propose alternate terms until an acceptance is issued by the seller via the network-based communications between distributed computing devices. Upon receiving the accepted RFQ message from the seller, the buyer issues a binding purchase confirmation after which the seller confirms receipt and respond with the delivery of the signal(s) in the timeframe specified. Signals can be transmitted in any volume defined within the purchase confirmation. By way of example and not limitation signal pricing can consist of both fixed price and price based upon an objective measured within the marketplace. The marketplace embodying the invention provides an anonymous trading system having a communicating network for transmitting electronic messages between distributed computers of signal sellers and signal buyers. A plurality of order input devices such as buyer and seller terminals are connected to the communication network. Each signal order device may generate price quotation messages, which include bid and/or offer prices and may communicate estimated price and analytics information to a buyer, or work with a central marketplace for order matching. A plurality of seller rules and pricing engines are connected to the network, to discover data, optimize purchases, and match bids and offers. Exchange of signals information can be accomplished in a locally managed agreement with a buyer outside of the marketplace. Or within marketplace which serves as the central clearing and settlement system for the execution of contracts and exchange of signals, during which history and transaction records are maintained. Within an advertising use of signals, at least one of party within the transaction is a publisher 400 (illustrated in FIG. 2), which is responsible for communicating with one or more consumers. The use of signal information, or activity by the publisher which was the result of signal information is tracked separately by the seller, the buyer and the marketplace. By way of example and not limitation, a grocery store X is a signal seller of men's shaving preferences, with Proctor and Gamble's Gillette as the signal buyer, in an advertising campaign managed by Ogilvy and Mather, and published in Facebook. Olgivy and Mather request signals from Store X Affinity to a competitor Schick for use to promote Gillette. Store X enters into an agreement to sell the shaving signal and responds to requests for any given consumer AFFINITY TO SCHICK [Value, Frequency, Recency] for each consumer. This signal data is combined with other data within the campaign manager and an offer is sent to each targeted consumer. Each offer contains a unique code or identifier, tying it to the campaign and to the signals usage. The signals used within the campaign can be tracked for each offer published, and for Consumers who redeem the offer with the unique code or identifier.

Trackable behaviors are defined within the marketplace and may include by way of example and not limitation: purchase with one time use code, purchase with credit card, location, registration, viewing of a web site, opening of email, phone call or viewing of a television show or commercial. Marketplace rules require participants to record defined behaviors and object identifiers, which are correlated to a signal, object, event or behavior. By way of example and not limitation, an objective behavior for an automotive advertiser is consumer presence in an automotive show room. The automotive show room has a Wi-Fi hot spot which identifies devices which are present. The Wi-Fi hotspot is a signal provider. The presence signal for any given device identified by the Wi-Fi provider is of value to the campaign manager. Hence the Wi-Fi provider sells data to the automotive campaign manager.

Within the signals marketplace or virtual marketplace or exchange, signals from multiple sources can be combined to identify objects. Similarly, object correlation to other objects, object correlation to behaviors, object correlation to events, object correlation to states, are tracked so that the marketplace requests will match corresponding data. By way of example and not limitation, objects such as: a person, a car, and a computer can all be correlated. Each of these objects can also have behaviors that can be correlated using a correlation engine, which may be provided in the centralized server computer or distributed among computers in communication over a network.

By way of example and not limitation if the signal AFFINITY_TO_CITY (New York) was combined with AFFINITY_TO_THEATER the target audience of likely Broadway ticket purchasers could be developed. A statistical engine within the marketplace cross correlates signal performance for any given objective. The statistical engine assesses the performance of signals both in isolated and combined usage, thus retaining the ability to assess value for a single signal within the marketplace and its participants. In addition to combining signals, the marketplace statistical engine also includes random samples of other signals. Thus, signal sellers are required to support analytics driven requests for their signals data to assess the cross correlation of signals. In this way the marketplace may make automated suggestions of alternate data sources which may improve price-performance of a given objectives.

As illustrated in FIG. 2, the schematic diagram illustrates components within a signal marketplace and/or exchange of signals between signal sellers and signal buyers, and methods or processes associated with their interaction.

Federated Data Centralized Intelligence. With any given seller correlations can be held remotely with object behavior and state estimated from both internal and external data. Significantly, this remote data correlation is shared with the centralized marketplace to assist with buyer discovery and object feedback. This approach allows each signal seller to control their data within their own environment, and perform analysis locally to provide a standardized result set to data buyers. This standardized result set provides security to the owner of the data as to not allow unapproved usage and further dissemination. The result set and marketplace allow for the tracking of the benefit that this signal or indicator provided to a given objective (example: marketing campaign). It also allows the seller to control the price of the response based upon the benefit to which it provides, understanding that it will provide different benefits to different buyers and different usages.

The computer-implemented method for indexing distributed data in a distributed data network in which file metadata and signal types related to unique keys are temporarily centralized within a marketplace. The method of invention calls for assigning and using a unique key to identify signals, which correlates to the key and returns it to the marketplace where it can be combined with other data sources. A key-value store built up in rows for the marketplace metadata, and updated by each node through response and direct participant edits. Each of the rows has a composite row key and a row value pair, also referred to herein as key-value pair.

Also, as illustrated in the figures, in particular in FIG. 1 and FIG. 2, a method of construction of signals/indicators directly between signal sellers and signal buyers and/or within a data marketplace to express: event, object state, change in state, behavior of an object, relationship to another object, relationship to a behavior, economic indicators, relevance to an objective, near-real-timeliness, frequency, recency, predictive accuracy, fidelity, reputation of the signal, reputation of the seller, affinity to a target, usefulness to an objective, and combinations thereof of a given input value is illustrated (generally referenced 2000 in FIG. 2), including the following:

Pricing signals data (signals) within a market of buyers and sellers based upon performance of indicators toward an objective.

A self-organizing network for construction and exchange of signal information between signal sellers and signal buyers.

A method of using data indicators from one or more sources each source priced separately within a data marketplace to target consumers in campaigns operating through one or more advertising publishers. (Advertiser 100, Campaign Manager 150, Signal Data Marketplace 200, Marketplace Analytics 250, Publisher (Distributor) 400), in particular for campaign management, which may further include consumer 500 permissions including Consumer Rules 550 and Consumer Pricing 570, and other Seller-based components 300, including Seller Rules and Pricing 320, Signal or Indicator Construction 340, Seller Data Correlation Engine 360, Seller Unstructured Data 370, and Seller Structured Data 380).

The present invention systems and methods may further include the following: Performance based advertising within a signal data marketplace 200 with publishing targeted and traceable advertising based upon information sourced from the signals marketplace or exchange. Examples of traceable advertising include one-time use codes, coupons, discounts, loyalty, mobile application behavior, location, digitally stored incentives, and combinations thereof 450.

Registration of signal providers (data sellers) in a shared directory 200-300.

Registration of signal types offered by signals providers in a shared directory 300, 320, 340, 360.

Registration and participation of advertisers (signal buyers) in a signals marketplace or exchange 100, 150, 200.

Registration and participation of content distributors in a signals marketplace or exchange 400, 200.

Registration and participation of consumers in a signals marketplace or exchange 500-550, 200.

Method of governing exchange of consumer information within a data marketplace that is dependent on consumer permission and consumer defined fees 550-200.

Rules governing the exchange of signals in a marketplace 200.

Creation of advertising campaigns using distributed signals, i.e., wherein the signals are provided from different sources.

Method of automated signal selection within a data marketplace, based upon signal price performance and relevance.

The Method of communicating signal performance and pricing information within a marketplace (marketplace analytics 250).

The method of purchasing remote signals via dynamic pricing in a bid/response within a federated marketplace 220.

Method of tracking the performance of federated indicators/signals within a data marketplace, based upon behavior (e.g., web site visit), location, card transaction information, redemption codes, loyalty cards or other external object observations, and events.

Method of pricing indicators within a data marketplace based upon behavior 600 web site visit, social sharing, location, card transaction information 650, redemption codes, and loyalty cards, as illustrated in FIG. 2.

Method of settling payment between buyer and seller 700, 320, 270, 150, 100 based upon redemption, coupon, one time code, payment, location, registration or other purchase information to confirm consumer behavior within a distributed data marketplace.

Identification of consumer marketing channel preference through signal availability, point of sale purchase information and other redemption information.

Use of consumer location information to inform effectiveness of advertising within a signals marketplace.

Use of encrypted credit card to confirm purchase within an advertising campaign in a federated signals marketplace.

Use of encrypted credit card information to inform object behavior for multiple buyers in a federated marketplace.

Use of encrypted consumer ID within retailer purchase history to confirm purchase within an signals based advertising campaign

Technical interaction and message exchange between signal buyers and sellers.

Process of exchanging requested purchase of data from a data provider within a data marketplace.

Statistical method for optimizing signal selection for advertising campaigns operating with a signals marketplace or exchange.

Statistical method for optimizing advertising distribution channel based upon signal information held by a multitude of participants in a federated signals marketplace.

Method of defining campaign types supported by signal marketplace. Campaigns can begin with target or campaigns can be managed by distributor in a bid for consumer access by competing campaigns.

Protection of consumer information in shared signals, and further including steps for protecting consumer anonymity in the exchange of signal information.

Clearing and settlement of signal exchange between participants in a marketplace based upon signal purchase agreements and signal performance information.

Method restraining signal exchange through rules based upon local laws of each transaction participant.

Method of selling indicators through marketplace agreements with price based upon advertising performance.

Method of Sharing revenue for consumer purchases with signal providers based upon measured object behavior, events, object states, or object performance 600.

Method of Settlement of financial obligations in a data marketplace which may include unique signal identifiers, signal agreements, consumer behavior, consumer payment, seller flat fees, seller performance fees, and consumer revenue sharing 270.

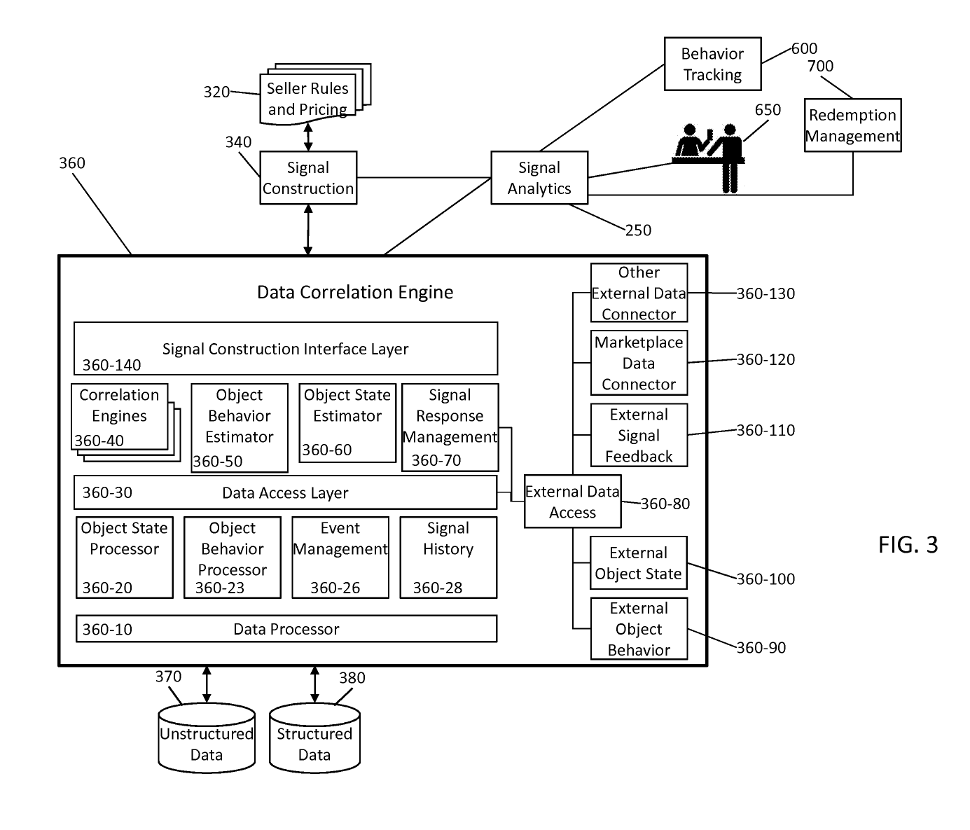

Referring now to FIG. 3, a signal data correlation engine 360 is illustrated including the components of a signal correlation interface layer 360-140, a signal data access layer 360-30 and a data processor 360-10; wherein the signal correlation interface layer 360-140 further includes: a correlation engine 360-40, an object behavior estimator 360-50, an object state estimator 360-60, a signal response management 360-70 having external data access 360-80. The signal data access layer further including an object state processor 360-20, an object behavior processor 360-23, an event manager 360-26, and signal history 360-26. The external data access is further related to external signal feedback 360-110, a marketplace data connector 360-120, an other external data connector 360-130, an external object state 360-100, and an external object behavior 360-90. The signal construction 340 from unstructured data 370 and structured data 380 also relates to the signal/seller data correlation engine 360 and seller rules and pricing 320. Signal analytics 250 is related to the data correlation engine 360 as well as behavior tracking 600 of behavior (including by observer) 650 and in the case of advertising, redemption management 700.

The object behavior estimator uses one or more statistical engines to predict behavior of an object based upon remote data, history and external signals (which represent events or stimuli). Objects such as people have a current state (in transit, having a baby, sitting at home) and historical behavior patterns that are both dynamic and complex. For example, historically when a person (Joe) travels to Chicago he has historically flown by United Airlines, stays at a Marriott, and eats at a steak chain restaurant for dinner. This information is held by many observers such as airlines, credit card companies, hotel chains, mobile phone companies, etc. Thus the object Joe has behaviors that are correlated to travel to Chicago. One observation of Joe in Chicago, or travelling to Chicago may be sufficient to estimate behavior by a multitude of observers.

Observers which sell their observations in the data marketplace are signal sellers. There are two primary flows by which a Signal Sellers (or signal owners) interact with a Signal Buyer: Buyer Initiated Request for Signal, and Seller Initiated Signal.

A Buyer Initiated Signal typically requests predict behavior of an object from historical observation information. For example the signal request of affinity to City, with the object context of the city of Chicago for object Joe, could be sent to an Airline Observer. In this example, the airline observer would correlate their historical travel data on passenger travel to Chicago for object Joe and return information regarding the recency and frequency of Joe's travel to Chicago. An Object Behavior Estimator could further predict the future travel based not only on an Airline observer's historical data, but their data correlated to external data such as a business conference, or another objects actions and behaviors (example Joe always travels with Susan to Chicago). Within the distributed (or federated) signals marketplace, each observer retains the correlation to external data signals, not based upon the data itself. For example the Correlation engines for the airline above would hold both internal correlation of Joe's travel preferences toward an external signal request, and the correlation of airline data to other external objects and behaviors (Susan's travel and conference events). The airline would not know the identity of the object Susan, but only that there is a strong correlation to an external object behavior (Susan is traveling to Chicago). Neither would the airline know that the external event was a specific conference. To summarize, the statistical machines within the data correlation engines and the estimators provide correlation of internal data to external objects and behaviors. These correlations allow for prediction of current state and behavior to external stimuli, with external information protected by the signals construct.

In a Seller Initiated Signal, the observation signal has buyers that have registered for the observation, without historical context. In this model it is the buyer that has correlated an external signal (from the seller) toward an objective. An example of a Seller Initiated Signal is an Airline with a signal Airline-Ticket-Purchase by Object at Time. In this example, the Seller Initiated Signal is an Event, which one or more buyers have chosen to register for within the Signals Marketplace, and the Seller has agreed to terms, which are contained within the Marketplace Contract Management System. For example, when Joe purchases an airline ticket, the Airline (acting as Signal Seller) informs approved signal buyers Marriott and Hilton that Joe will be travelling to Chicago. Event signals are a primary real time mechanism for selling and transferring observations. The signals marketplace provides for the dissemination of approved real time data within the signals metaphor to protect the contents of the information (or underlying data), its usage and performance, and realize value of the information based upon time decay. The signal Purchased-Airline-Ticket has a higher value within 1 second of the event, than at 10 minutes, 10 hours, or 10 days. The marketplace provides for price prediction based upon the time decay, and for measurement of performance of the event signal during its use. For example, if the hotel chain Hilton was able to use the signal Purchased-Airline-Ticket to secure a reservation by Joe, where Joe had previously stayed at Marriott, Hilton received a known value in the incremental sale of that Chicago room. If the Signal Purchased-Airline-Ticket was the only signal used in a campaign to Joe, than the performance of the signal toward the objective is known. If Purchased-Airline-Ticket was used in conjunction with other information the marketplace will calculate the proportional effectiveness of the Airline signal in the context of other signals used.

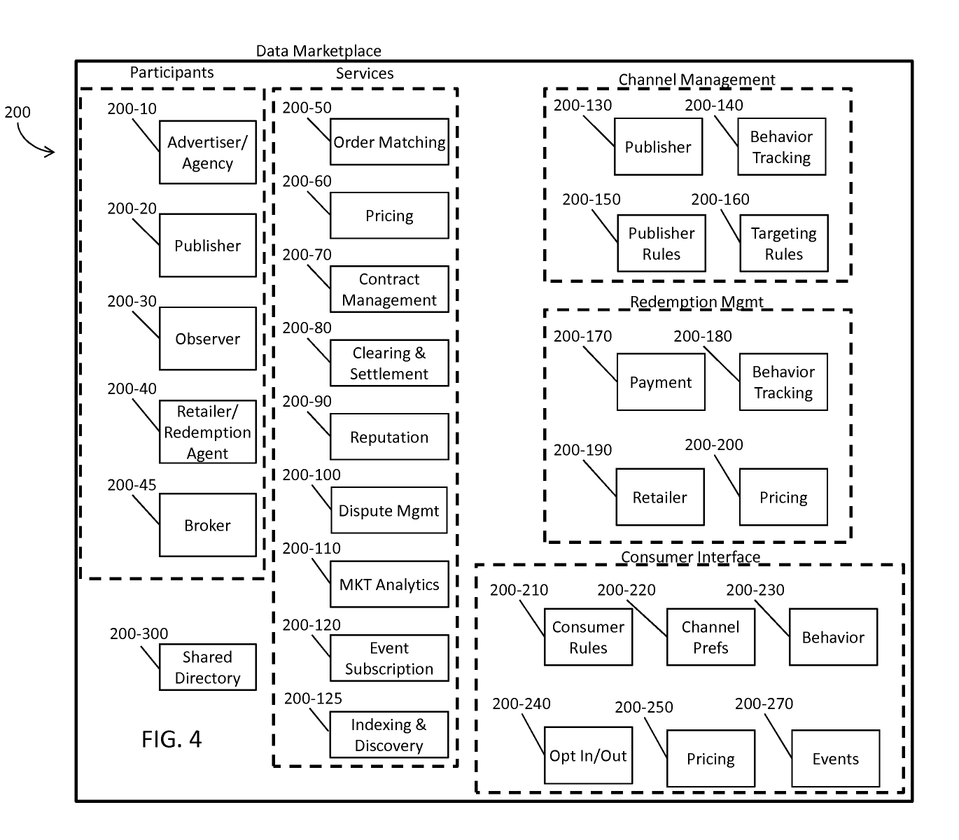

Referring now to FIG. 4, the signal data marketplace 200 is illustrated, providing components and relationships for participants, services, channel management, registration management, and consumer interface. For the participants, general examples within and advertising context are illustrated for an advertiser and/or agency 200-10, a publisher 200-20, an observer 200-30, a retailer and/or redemption agent 200-40, and a broker 200-45. For the automated services provided by the remote/centralized server computer for the virtual signal marketplace or exchange, examples are illustrated for order matching 200-50, pricing 200-60, contract management 200-70, clearing and settlement 200-80, reputation 200-90, dispute management 200-100, market analytics 200-110, event subscription 200-120, and indexing and discovery 200-125. For channel management provided by the virtual signal data marketplace 200, a publisher 200-130, behavior tracking 200-140, publisher rules 200-150, and targeting rules 200-160 are provided for automated steps within the signals marketplace or exchange. Functions of redemption management further include payment 200-170, behavior tracking 200-180, retailer 200-190, and pricing 200-200. Functions of consumer interface provided by the virtual signal marketplace include consumer rules 200-210, channel preferences 200-220, behavior 200-230, opt in/opt out 200-240, pricing 200-250, and events 200-270.

By way of additional background for the signal marketplace of the present invention, it is a significant factor how the federated data for the distributed signals is used. As opposed to “sharing lists” and joining information within a single database. Federated data keeps raw data localized with the owner responsible for disclosure, usage, pricing, security, and privacy. Within a data marketplace federated data providers (sellers) use signals as a way to protect sensitive information. Signals (or indicators described hereinabove) are a type of meta data indicators that are based upon information in control of the data sellers. These signals or indicators require input context and are sold for purposes explicitly defined within the signal marketplace. For example, in an AFFINITY_TO_CITY signal example, consumer flight records are never shared nor is the traveler's current location, rather the signal response can reflect how often or how recently an object was associated with a given city. Signals create scarcity and enable control both of which are critical in any functional marketplace. The value of any good is dependent on quality, availability, use, alternatives and price. The virtual signal marketplace performs analysis on signal results to determine effectiveness and value. This analysis and effectiveness information is communicated to all participants, which informs the market of potential buyers and sellers.

The efficacy of a signal is dependent upon the following factors or considerations: a) the signal's owner must have sole discretion to permission access, price, restrict usage and dissemination; b) the exchange of signal information must be and secured from external observation to protect against data leakage and tampering, since there can be no efficient market for the data or signals if they can be obtained elsewhere at a lower cost; c) each signal must be retain information on its identity, ownership, destination, rules and usage constraints enforced through its life cycle of usage by all parties that leverage signals directly or indirectlyn, d) The signal must contain information that the owner can create and release, e) the use of signal information must be measured which includes information on the buyer, objects, behaviors, states, events, status of agreement with marketplace, agreement with the buyer (if any), consumer constraints (if any), price offered, planned usage, and combinations thereof; the marketplace processes, systems, and services to protect the exchange, assure secure delivery, track usage, track value generated, settle funds, issue receipt, deliver auditability; and combinations thereof.

There are different control requirements on “consumer information” (or personally identifiable information or PII), proprietary information, object behavior information, object state information and other generic information. Some of these control requirements are driven by regulatory issues or requirements. Some information can only be exchanged to another party where an agreement is in place (i.e., a closed market). The control elements of a signal include the following: a) Signal type: Open, Restricted, PII; b) Signal Price: Market, floor; value generated c) Buyer Information or profile; c) consumer consent information (if any).

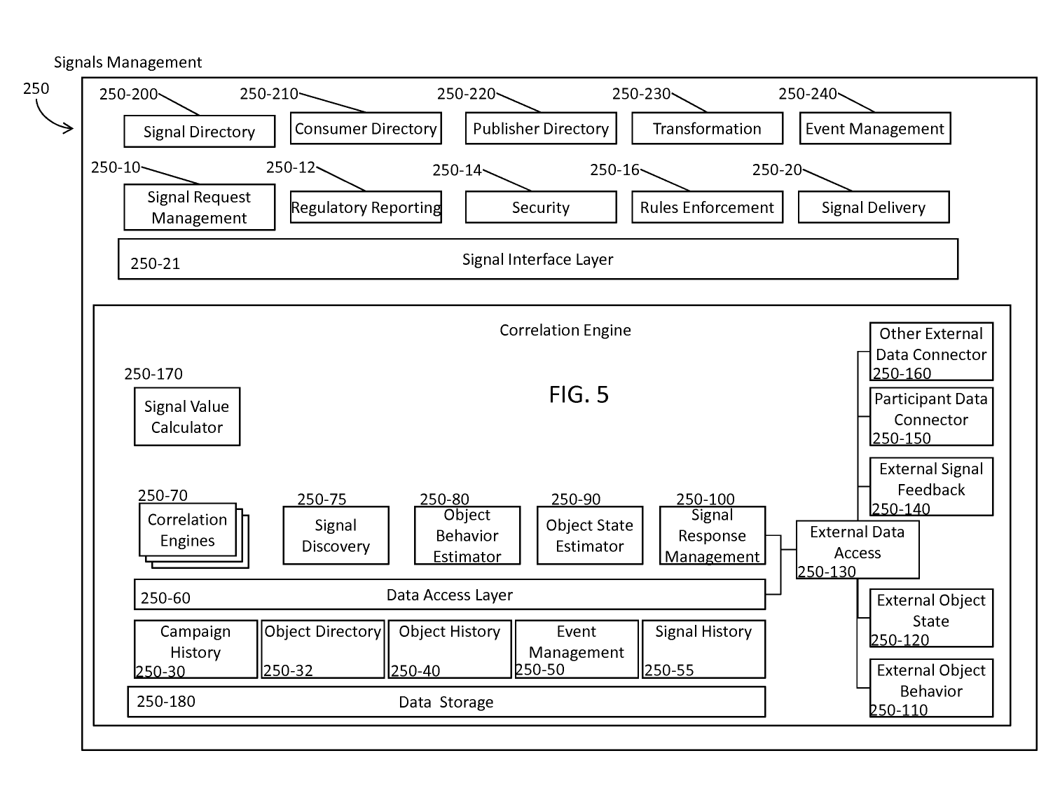

FIG. 5 is a schematic diagram of an embodiment of the invention illustrating components and functions relating to signals management, generally referenced 250. The components include: Signal Directory 250-200; consumer Directory 250-210; Publisher Directory 250-220; Transformation 250-230; Event Management 250-240; Signal Request Management 250-10; Regulatory Reporting 250-12; Security 250-14; Rules Enforcement 250-16; Signal Delivery 250-20; Signal Interface Layer 250-21; and a Signal Management Correlation Engine further including 250-170; Correlation Engines 250-70; Signal Discovery 250-75; Object Behavior Estimator 250-80; Object State Estimator 250-90; Signal Response Management 250-100; External Data Access 250-130; External Object State 250-120; External Object Behavior 250-110; Other External Data Connector 250-160; Participant Data Connector; 250-150; External Signal Feedback 250-140; and Data Storage 250-170.

After defining the signals to sell, and registering their corresponding rules and constraints, signals information is exchanged within the virtual signal marketplace. There are five (5) primary data flows between a signal provider and the signal marketplace or signal exchange, including:
1) RFQ. Request for quote. In this data flow, a prospective buyer will request a price from the signal provider. The signal buyer provides: ID, signal(s) requested, input parameters (e.g., destination city, campaign type, price offered (per item and per success), time, expiry time, minimum fill, maximum, settlement. Along with this information the signal marketplace or signal exchange will also provide Buyer ID reputation information.
2) RFQ Response. Signal provider will either respond with an acceptance of order and time/quantity to fill, or a respond with alternate price/denial. The signal marketplace or signal exchange provides “optional” seller side software to manage this interaction. Rules surrounding minimum price, data effectiveness and buyer ID are incorporated to response. If offer is accepted, signal marketplace or signal exchange will begin tracking of the transaction order.
3) Purchase Confirmation. Buyers will issue purchase confirmation for approved RFQs. Within our marketplace agreement, a purchase confirmation is a commitment by the buyer to pay for information within the terms of the Commerce Signals Marketplace Agreement.
4) Signal Delivery. Signal provider provides the signals and buyer confirms receipt
5) Settlement. Transaction Reference number, quantity provided, time provided, item fees (if any), redemption fees (if any), redemptions to date, redemption expiry period, amount paid, amount paid to date, dispute reference numbers, receipt confirmed.

The present invention creates a virtual market for data, wherein the underlying or actual data has been transformed into signals or indicators to protect the underlying data, while still providing information relating to the data that is actionable by signal buyers. Each data seller can develop their own signals or indicators, controlled by their own rules and corresponding correlation engine(s), which data they wish to sell to the outside world. For example a retailer could develop a signal “affinity for golf” with a result of 0-1. Consumers who buy golf balls, golf equipment would have a stronger signal based upon affinity. Golf marketers could subsequently use this information to better inform advertising, in particular for targeted advertising campaigns.

Signal buyers participate directly with signal sellers and/or in the marketplace to identify objects that they wish to influence or measure. Other entities, such as campaign managers, publishers, media companies take different roles in the measurement and influencing of the behavior of objects through the use of signal information. The virtual marketplace supports both buyer led transactions and seller led transactions. By way of example and not limitation seller led campaigns can begin with a publisher that has a relationship with a consumer of a given profile. Buyers can bid for the influencing the behavior of that consumer through the marketplace. Marketplace participants can assume multiple roles such as buyer, seller, and distributor.

Regardless of signal or indicator construction, signals must be registered to participate in the signal marketplace. To provide security to protect the signals within the marketplace, and to control signal dissemination or access and distribution to signals registered in the signal marketplace, multiple object identifiers can be used. By way of example and not limitation these include encrypted forms of e-mail address, card number, phone numbers, device ID, location, loyalty card and address as key for purchase of information from a seller. Thus the data seller or signal provider controls the information that is shared within the marketplace and with prospective buyers. These controls relate to access, viewing, downloading, copying, etc. and combinations thereof.

Technical communication protocols for signals include writing data of the buyer into a buyer computer application; notifying buyer computer application to send XML file when data has been written to the marketplace order computer application data file by the buyer computer application; monitoring the marketplace order computer application queue from the marketplace execution application for notification that data has been written to the data file by the buyer computer application; reading the data of the buyer computer application data file from the marketplace execution computer application upon detection of notification; notifying marketplace order computer application to send XML file when data has been written to the seller computer application data file by the marketplace order computer application; monitoring the seller computer application queue from the marketplace order application for notification that data has been written to the data file by the marketplace order computer application; notifying a buyer computer application read file when data has been read by the seller computer application from the marketplace order computer application data file; monitoring the seller read file from the marketplace order computer application for notification that data has been read from to the buyer computer application data file by the seller computer application to initiate further writing to the marketplace order computer application data file.

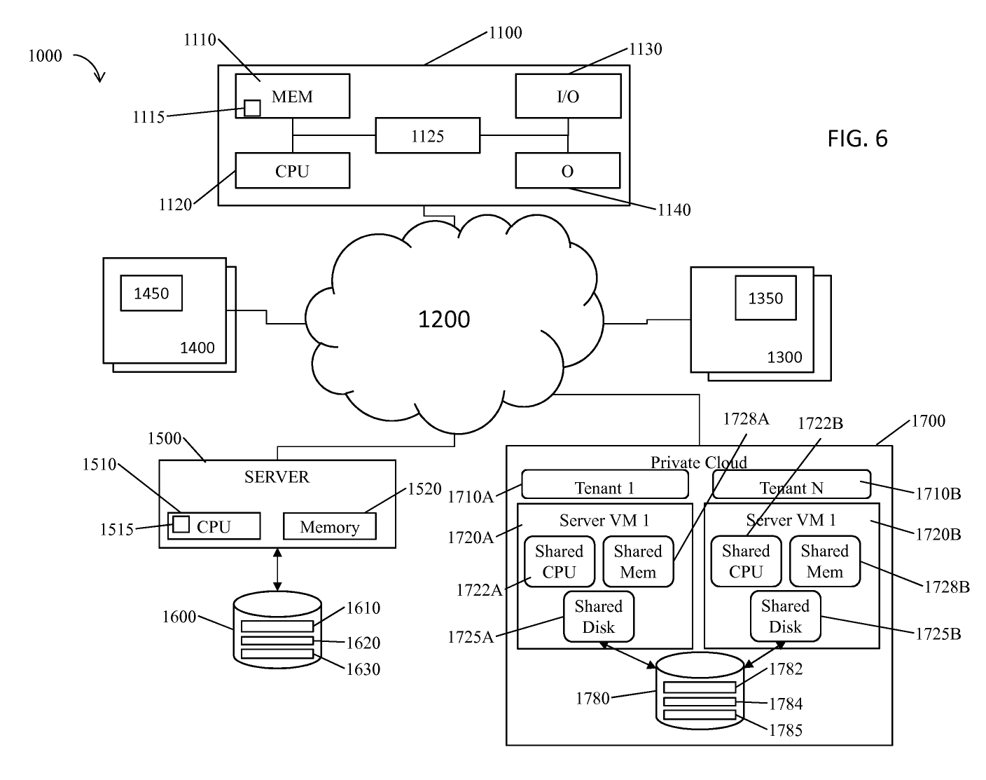

As illustrated in FIG. 6, the system 1000 is comprised of both dedicated servers 1500 and servers operating within a private cloud 1700. The dedicated servers 1500 contain: processing units 1510, memory 1520 data storage 1600. Dedicated servers 1500 are constructed, configured and coupled to enable communication over a network 1200. Servers 1720 operating within a private cloud 1700 leverage shared processing units 1722A, shared memory 1725A and shared disk 1728A are also configured and coupled to enable communications over a network 1200. The dedicated servers 1500 and cloud servers 1700 provide for user interconnection over the network 1200 using computers 1110 positioned remotely from the servers. Furthermore, the system is operable for a multiplicity of remote computers or terminals 1300, 1400 to access the dedicated servers 1500 and servers 1720A operating within a private cloud 1700 remotely. For example, in a request and reply architecture devices registered to marketplace participants may interconnect through the network 1200 to access data within dedicated servers 1600 and within the private cloud 1780. In preferred embodiments, the network 1200 is the Internet, or it could be an intranet, or any other network suitable for searching, obtaining, and/or using information and/or communications, including receiving the notification and providing a response.

The system of the present invention further includes an operating system 1515 installed and running on the dedicated servers 1500, enabling servers 1500 to communicate through network 1200 with the remote, registered devices. The operating system may be any operating system 1515 known in the art that is suitable for network communication. A memory within dedicated servers 1520 is interconnected with the server 1500. Memory 1520 may be integral with server 1500 or may be external to the server and interconnected therewith. A program of instruction 1620 is resident in memory 1520 within the parameters set by the operating system 1515 which accesses persistent storage 1600.

The system of the present invention further includes servers 1720A which support multiple tenants 1710A within a private cloud 1700 that share system resources through multiple virtual machines 1720A. Each virtual machine 1720A consists of an operating system installed and running on shared processing units 1722A, shared memory 1725A, shared persistent storage 1728A which access programmatic and user data 1782. The private cloud 1700 communicates through the network 1200 with remote registered devices. The operating system and virtual machines 1720A may be any such kind known in the art that is suitable for managing multi-tenant cloud services and network communication. Memory 1725A within shared cloud infrastructure is interconnected with each associated virtual machine 1720A according to the operating system running within the processing unity 1722A. A program of instruction 1782 is managed within memory 1725A upon retrieval by disk management 1728A within the parameters set by the operating system 1720 and virtual machine. Additionally, the following components are illustrated in FIG. 6: device 1100, instructions 1115, processor 1120, input/output interface 1130, bus 1125, memory 1350, 1450, instructions 1610, 1785 applications 1630, 1784, tenant N 1710B, server VM N 1720B, shared memory 1722B, shared disk 1728B and shared CPU 1725B.

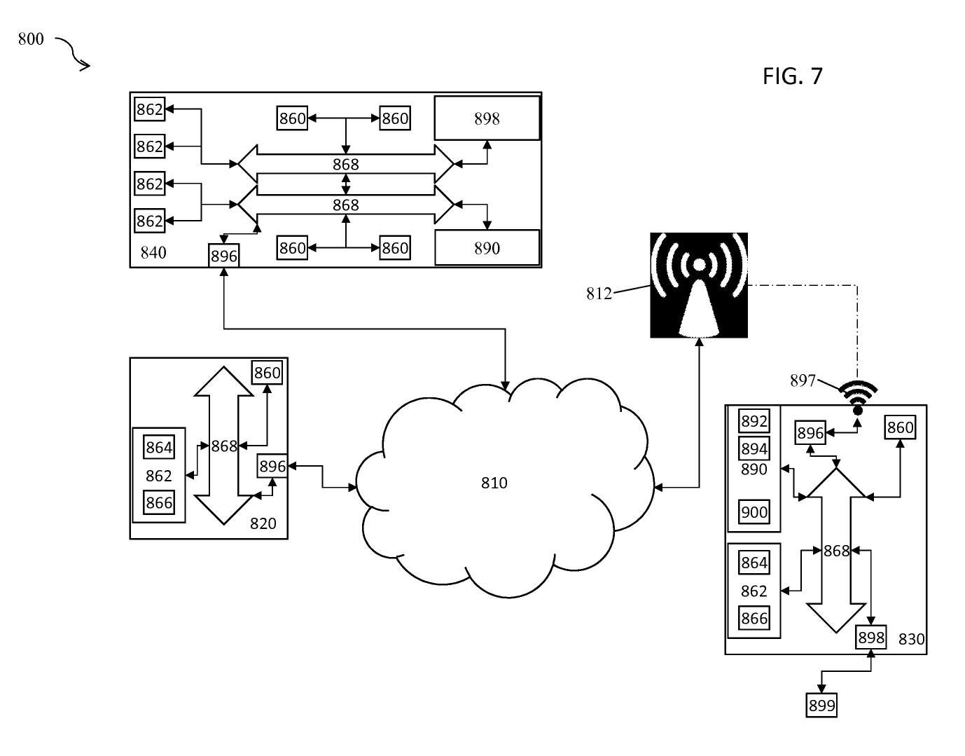

Additionally or alternatively to FIG. 6, FIG. 7 is a schematic diagram of an embodiment of the invention illustrating a computer system, generally described as 800, having a network 810 and a plurality of computing devices 820, 830, 840. In one embodiment of the invention, the computer system 800 includes a cloud-based network 810 for distributed communication via the network's wireless communication antenna 812 and processing by a plurality of mobile communication computing devices 830. In another embodiment of the invention, the computer system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital devices 820, 840, 850 and mobile devices 830, such as a server, blade server, mainframe, mobile phone, a personal digital assistant (PDA), a smart phone, a desktop computer, a netbook computer, a tablet computer, a workstation, a laptop, and other similar computing devices. The components shown here, their connections and relationships, and their functions, are meant to be exemplary only, and are not meant to limit implementations of the invention described and/or claimed in this document.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers) or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown in FIG. 7, a computing device 840 may use multiple processors 860 and/or multiple buses 868, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to the bus 868. Computing devices may communicate communication media through wired networks, direct-wired connections or wirelessly such as acoustic, RF or infrared through a wireless communication antenna 897 in communication with the network's wireless communication antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications or other data embodying any one or more of the methodologies or functions described herein. The computer readable medium may include the memory 862, the processor 860, and/or the storage device 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory or other solid state memory technology, disks or discs (e.g., digital versatile disks (DVD), HD-DVD, BLU-RAY, compact disc (CD), CD-ROM, floppy disc) or other optical storage, magnetic cassettes, magnetic tape, magnetic disk storage or other magnetic storage devices, or any other medium that can be used to store the computer readable instructions and which can be accessed by the computer system 800.

It is also contemplated that the computer system 800 may not include all of the components shown in FIG. 7 may include other components that are not explicitly shown in FIG. 7 or may utilize an architecture completely different than that shown in FIG. 7. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

In access management for signals within the signals marketplace according to the present invention, the following method is provided for granting access to signals controlled by corresponding signal owners in a virtualized or cloud-based computing system, the method steps within a signal owner computer constructed and configured for network-based communication with a remote server computer including the steps of: generating or constructing at least one rule associated with constraining or governing access to at least one signal, wherein the at least one signal corresponds to or represents a behavior of an object and/or an activity and/or an event associated with the object, wherein the at least one signal includes information about recency, frequency, and affinity, and wherein the behavior includes information about behavior recency, behavior frequency, and behavior affinity; storing the rule in a memory of the signal owner computer; receiving a request for access to the at least one signal by a buyer; automatically processing the request based on the at least one rule associated with the at least one signal; if the request complies with the at least one rule, then releasing the signal to the buyer; and tracking usage of the at least one signal via the network. Preferably, the at least one rule governs access to the at least one signal for a defined buyer and a defined use for the defined buyer.

The methods of the present invention may further include the steps of: granting or denying access to the at least one signal based upon the at least one rule for a defined use of the at least one signal by the corresponding at least one buyer; tracking access to the at least one signal in a database associated with the remote server computer; generating a listing that provides automated matching of the at least one signal with buyer candidates; automatically updating the at least one rule; providing and updating the at least one rule and updating constraints, exceptions, policies, pricing, competitors, reputation and/or availability of listings. The method may further include the steps of: transmitting the at least one signal and the at least one rule to the remote server computer, which is accessible by distributed signal buyers via the network; delivering the at least one signal to a signal buyer; monitoring use of the at least one signal by the signal buyers; receiving information from signal buyers confirming receipt of the at least one signal, and compliance with the at least one rule; retaining control of signal data within a defined use of the signal by a registered buyer, based upon the at least one rule; and/or the signal owner limiting signal availability to signal buyers and/or to a signal marketplace based upon the at least one rule.

In the methods of the present invention, the steps are provided within a federated community of signal providers within a data marketplace and provide for access management and associated policies impacting the availability of data within the data marketplace. Also, the methods of the present invention, the steps are provided within a community of federated signal buyers or a marketplace, and are operable to provide access management to the at least one signal locally by a signal provider or an indictor provider within the community or the marketplace.

Also, in methods for access to signals controlled by corresponding signal owners in a virtualized or cloud-based computing system, the method steps within a signal owner computer constructed and configured for network-based communication with a remote server computer include: generating or constructing at least one rule associated with constraining or governing access to at least one signal, wherein the at least one signal corresponds to or represents a behavior of an object and/or an activity and/or an event associated with the object, wherein the at least one signal includes information about recency, frequency, and affinity, and wherein the behavior includes information about behavior recency, behavior frequency, and behavior affinity; storing the rule in a memory of the signal owner computer; receiving a request for access to the at least one signal by a buyer; automatically processing the request based on the at least one rule associated with the at least one signal; if the request complies with the at least one rule, then releasing the signal to the buyer; and tracking usage of the at least one signal via the network; and retaining control of signal data within a defined use of the signal by a registered buyer, based upon the at least one rule.

The method steps are provided for a multiplicity of signal owner computers distributed throughout the network and in network-based communication with the remote server computer. For the systems and methods of the present invention, the at least one signal includes a signal type selected from the group consisting of: state signals, event signals, activity signals, behavior signals, relational signals, location signals, loyalty signals, purchase signals, social signals, and combinations thereof.

A system for providing access management for signals by corresponding signal owners in a virtualized or cloud-based computing environment according to the present invention includes: a remote server computer constructed and configured for network-based communication with at least one signal owner computer and at least one signal buyer computer; the at least one signal owner computer having a memory storing at least one signal that corresponds to or represents a behavior of an object and/or an activity and/or an event associated with the object, wherein the at least one signal includes information about recency, frequency, and affinity, and wherein the behavior includes information about behavior recency, behavior frequency, and behavior affinity; at least one rule associated with the at least one signal, which is stored in a memory of the signal owner computer; and a first signal value for a predetermined signal use corresponding to the at least one signal and at least one rule. The remote server computer provides for access management within a federated community of signal providers, and the remote server computer monitors use of the at least one signal based upon the at least one rule. Preferably, the at least one rule includes factors regarding: buyer identity, campaign type, signal requested, price, redemption signal type, purchase quantity, past performance of signal, past performance of campaign type, past performance of buyer, and combinations thereof. Also, the at least one rule is associated with a type selected from the group consisting of: event signals, activity signals, behavior signals, relational signals, location signals, loyalty signals, purchase signals, social signals, and combinations thereof.

Also, the system provides for limiting signal availability based upon a rules engine that includes the at least one rule from each of the signal owners that automatically considers buyer identity, campaign type, signal requested, price, redemption signal type, purchase quantity, past performance of signal, past performance of campaign type, past performance of buyer, and combinations thereof. Additionally, preferably the at least one signal is indexed, abstracted and/or anonymized from their data source to protect the identity of the signal owner. As described hereinabove in the signals marketplace, the buyer candidates desiring access to the signals have corresponding objectives for buying signals and signals data that include consumer behavior(s).

For the systems and methods of the present invention, the at least one signal includes a signal type selected from the group consisting of: state signals, event signals, activity signals, behavior signals, relational signals, location signals, loyalty signals, purchase signals, social signals, and combinations thereof. Also, the systems and methods of the present invention include at least one control that impacts the availability of a signal corresponding to the behavior of the object, the activity, and/or the event.

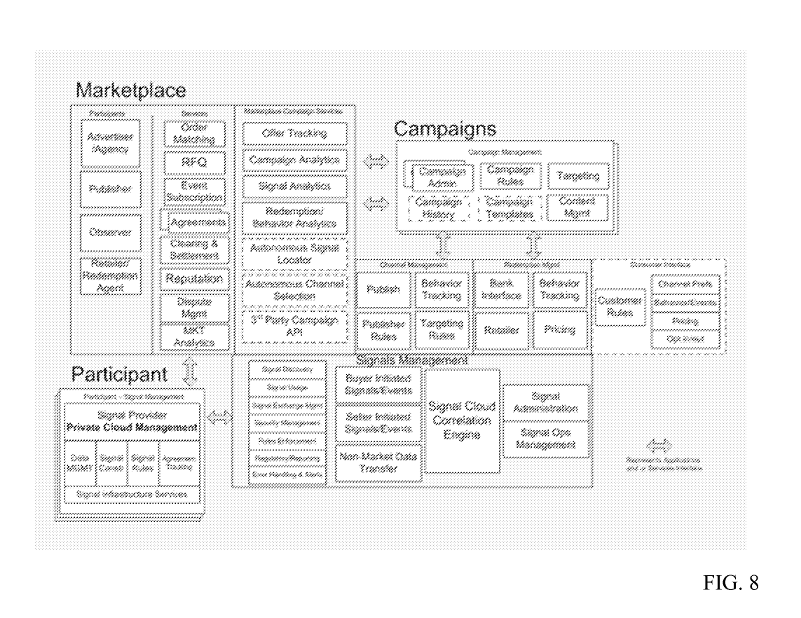

Referring again to the figures, consider in particular to FIGS. 8-12 which more particularly illustrate elements and steps of signals access management for the present invention systems and methods. FIG. 8 is a schematic diagram of an embodiment of the invention illustrating components and functions of the signals data marketplace, campaigns, and participants in relation to signals access management. Preferably, applications and/or services interfaces are provided between the signals marketplace, campaigns for advertising and marketing, participants including signal provider and signal infrastructure services for data management, signal construction, signal rules, and agreement tracking within a cloud-based computing system and constructed and configured in network-based communication with the signals marketplace and signals management and signals access management cloud-based systems and methods as described and claimed herein.

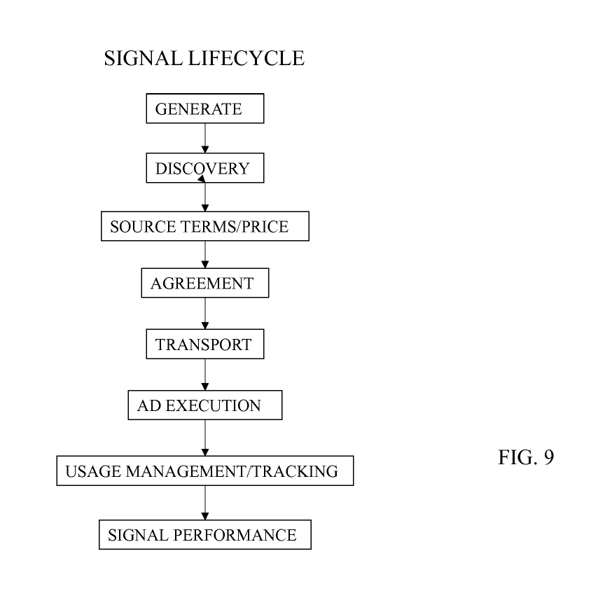

FIG. 9 is a flow diagram of an embodiment of the invention illustrating signal lifecycle including steps associated with each signal within the signals marketplace: generate, discovery, source terms and price, agreement, transport, ad execution, usage management and tracking, and signal performance.

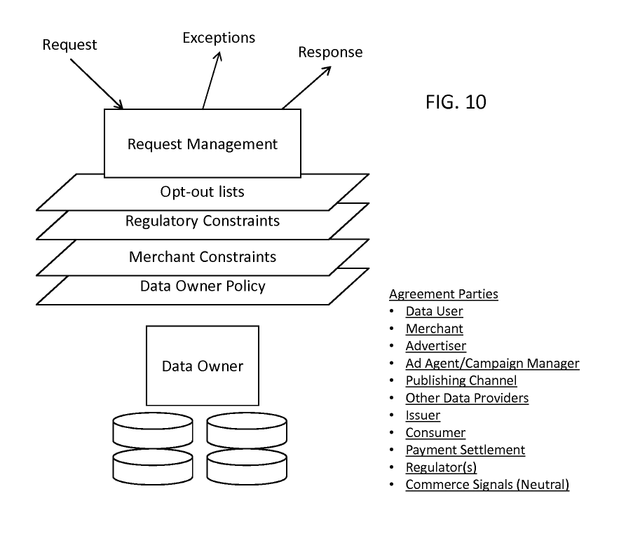

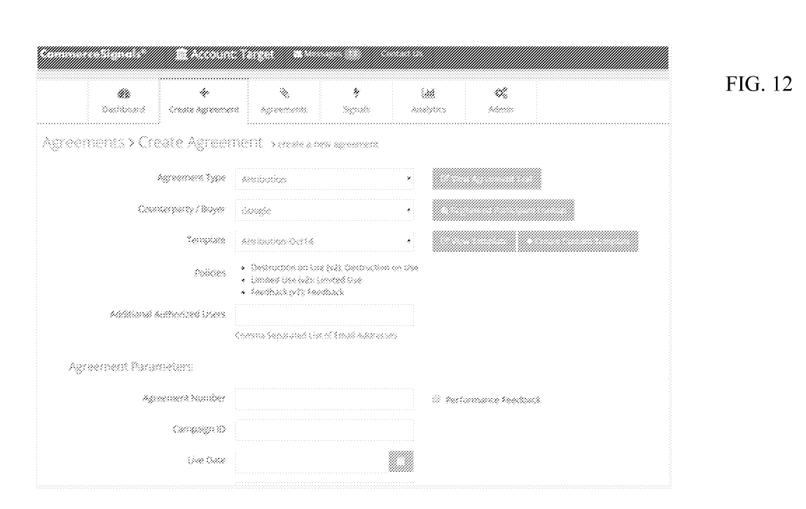

The present invention further provides for signal or indicator sellers to manage multiple layers of rules and constraints with access management graphic user interfaces (GUIs) which can be located either centrally within the marketplace, or locally within the sellers federated data systems, as illustrated in FIG. 10 showing the layers of control provided by signals access agreements, and the GUI illustrated in FIG. 12. FIG. 10 is a schematic diagram of an embodiment of the invention illustrating components and functions relating to request management for signals based upon the request inputs received by the signals marketplace of the present invention. The request is received and processed by a server computer based upon the agreement terms stored in at least one database for governing the access to signals available. The request is considered based upon opt out lists, regulatory constraints, merchant constraints, at least one policy, and any exceptions are indicated along with a response output from the system. The agreements govern all parties within the marketplace, including data owners, merchants, advertisers, campaign managers, advertising agents, publishing channels, other data providers or data owners, issuers, consumers, payment settlement entities, regulators, and commerce signals or a neutral entity overseeing the signals marketplace and the federated signals data.

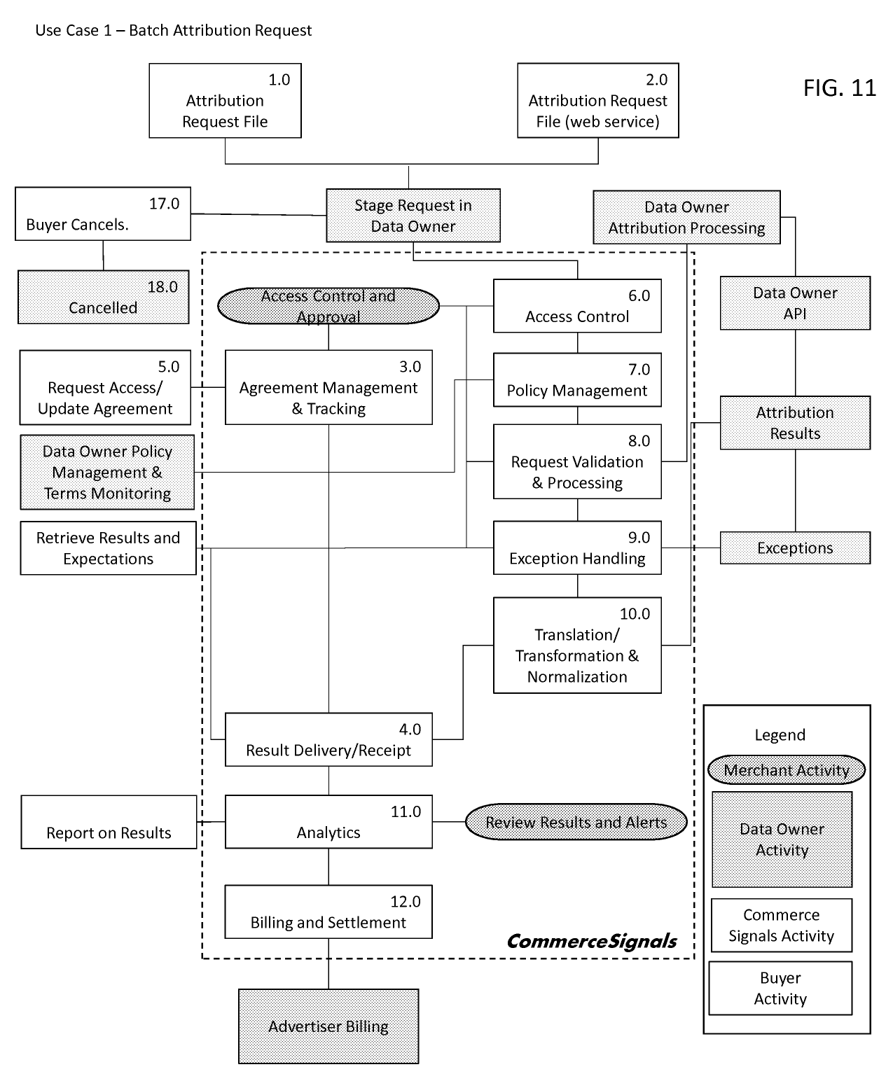

FIG. 11 is a schematic diagram of an embodiment of the invention illustrating components and functions relating to a use case for batch attribution request for signals access management, with the data owner illustrated by way of example as a corporate entity. An attribution request file 1.0 or attribution request file (web service) is input and the stage request in data owner is provided and considered automatically based upon the access control 6.0, policy management 7.0, request validation and processing 8.0, exception handling 9.0, and translation, transformation, and normalization 10. Agreement management and tracking 3.0 is also provided within the access control and approval, and includes request access and updating agreement processes. Buyer cancellation 17.0 and a corresponding request cancellation 18.0 is provided as an alternative to the access control and approval function within the system. Policy management and terms monitoring, and retrieving results and exceptions are provided in connection with their corresponding steps for processing the request through signals access control and approval of the present invention. Data owner attribution processing is provided via an API for attribution results and exceptions handling. If approval is provided, then result delivery and receipt 4.0 follow, as well as analytics 11.0 for reviewing results and alerts and reporting on results steps. Then, billing and settlement 12.0 including steps of payment for attribution and advertiser billing are provided.

FIG. 12 shows a graphic user interface (GUI) screen shot illustration of an embodiment of the invention showing inputs for creating agreements and parameters governing signals access and management. Remote inputs are provided by the data owner via computing device constructed and configured for communication via a network to the signals access management interface of the at least one server and database(s) of the systems of the present invention for a signals marketplace. The data owner provides inputs for generating and updating agreements governing signals representing the data. Agreement type is selected by predetermined agreements within the system; at least one counterparty or buyer is identified. Preferably, templates are provided for each agreement type within the system. Agreement parameters, policies, restrictions or limitations of use, feedback, and combinations are provided by the data owner for inclusion in the electronic agreement governing the signals use and access to signals according to the present invention systems and methods.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for granting access to signals controlled by corresponding signal owners in a virtualized or cloud-based computing system, the method steps within a signal owner computer constructed and configured for network-based communication with a remote server computer comprising:
generating or constructing at least one rule associated with constraining or governing access to at least one signal, wherein the at least one signal corresponds to or represents a behavior of an object and/or an activity and/or an event associated with the object, wherein the at least one signal includes information about recency, frequency, and affinity, and wherein the behavior includes information about behavior recency, behavior frequency, and behavior affinity;
storing the rule in a memory of the signal owner computer;
receiving a request for access to the at least one signal by a buyer;
automatically processing the request based on the at least one rule associated with the at least one signal;
if the request complies with the at least one rule, then releasing the signal to the buyer; and
tracking usage of the at least one signal via the network.

2. The method of claim 1, wherein the at least one rule governs access to the at least one signal for a defined buyer and a defined use for the defined buyer.

3. The method of claim 1, further including providing at least one control that impacts the availability of a signal corresponding to the behavior of the object, the activity, and/or the event.

4. The method of claim 1, further including the step of granting or denying access to the at least one signal based upon the at least one rule for a defined use of the at least one signal by the corresponding at least one buyer.

5. The method of claim 1, further including the step of tracking access to the at least one signal in a database associated with the remote server computer.

6. The method of claim 1, further including the step of generating a listing that provides automated matching of the at least one signal with buyer candidates.

7. The method of claim 6, wherein the buyer candidates have corresponding objectives for buying signals and signals data.

8. The method of claim 7, wherein the objectives include consumer behavior(s).

9. The method of claim 1, further including the step of automatically updating the at least one rule.

10. The method of claim 1, further including the step of providing and updating the at least one rule and updating constraints, exceptions, policies, pricing, competitors, reputation and/or availability of listings.

11. The method of claim 1, wherein the at least one rule is associated with a type selected from the group consisting of: event signals, activity signals, behavior signals, relational signals, location signals, loyalty signals, purchase signals, social signals, and combinations thereof.

12. The method of claim 1, wherein the steps are provided for a multiplicity of signal owner computers distributed throughout the network and in network-based communication with the remote server computer.

13. The method of claim 12, wherein the steps are provided within a federated community of signal providers.

14. The method of claim 12, wherein the steps are provided within a data marketplace and provide for access management and associated policies impacting the availability of data within the data marketplace.

15. The method of claim 12, wherein the steps are provided within a community of federated signal buyers or a marketplace, and operable to provide access management to the at least one signal locally by a signal provider or an indictor provider within the community or the marketplace.

16. The method of claim 1, further including the step of transmitting the at least one signal and the at least one rule to the remote server computer, which is accessible by distributed signal buyers via the network.

17. The method of claim 1, further including the step of delivering the at least one signal to a signal buyer.

18. The method of claim 17, further including the step of monitoring use of the at least one signal by the signal buyers.

19. The method of claim 1, further including the step of receiving information from signal buyers confirming receipt of the at least one signal, and compliance with the at least one rule.

20. The method of claim 1, wherein the at least one signal includes a signal type selected from the group consisting of: state signals, event signals, activity signals, behavior signals, relational signals, location signals, loyalty signals, purchase signals, social signals, and combinations thereof.

21. The method of claim 1, further including the step of retaining control of signal data within a defined use of the signal by a registered buyer, based upon the at least one rule.

22. The method of claim 1, further including the step of the signal owner limiting signal availability to signal buyers and/or to a signal marketplace based upon the at least one rule.

23. The method of claim 22, wherein the at least one rule includes factors regarding: buyer identity, campaign type, signal requested, price, redemption signal type, purchase quantity, past performance of signal, past performance of campaign type, past performance of buyer, and combinations thereof.

24. A system for providing access management for signals by corresponding signal owners in a virtualized or cloud-based computing environment comprising:
a remote server computer constructed and configured for network-based communication with at least one signal owner computer and at least one signal buyer computer;
the at least one signal owner computer having a memory storing at least one signal that corresponds to or represents a behavior of an object and/or an activity and/or an event associated with the object, wherein the at least one signal includes information about recency, frequency, and affinity, and wherein the behavior includes information about behavior recency, behavior frequency, and behavior affinity;
at least one rule associated with the at least one signal, which is stored in a memory of the signal owner computer; and
a first signal value for a predetermined signal use corresponding to the at least one signal and at least one rule.

25. The system of claim 24, wherein the at least one signal is indexed, abstracted and/or anonymized from their data source to protect the identity of the signal owner.

26. The system of claim 24, wherein the remote server computer provides for access management within a federated community of signal providers.

27. The system of claim 24, wherein the remote server computer monitors use of the at least one signal based upon the at least one rule.

28. The system of claim 24, signal availability is limited based upon a rules engine that includes the at least one rule from each of the signal owners that automatically considers buyer identity, campaign type, signal requested, price, redemption signal type, purchase quantity, past performance of signal, past performance of campaign type, past performance of buyer, and combinations thereof.

29. A method for access to signals controlled by corresponding signal owners in a virtualized or cloud-based computing system, the method steps within a signal owner computer constructed and configured for network-based communication with a remote server computer comprising:
generating or constructing at least one rule associated with constraining or governing access to at least one signal, wherein the at least one signal corresponds to or represents a behavior of an object and/or an activity and/or an event associated with the object, wherein the at least one signal includes information about recency, frequency, and affinity, and wherein the behavior includes information about behavior recency, behavior frequency, and behavior affinity;
storing the rule in a memory of the signal owner computer;
receiving a request for access to the at least one signal by a buyer;
automatically processing the request based on the at least one rule associated with the at least one signal;
if the request complies with the at least one rule, then releasing the signal to the buyer; and
tracking usage of the at least one signal via the network;
retaining control of signal data within a defined use of the signal by a registered buyer, based upon the at least one rule.
